(19) United States
(12) Patent Application Publication
(10) Pub. No.: US 2005/0027713 A1
(43) Pub. Date: Feb. 3, 2005

(54) Administrative reset of multiple passwords

(76) Inventors: Kim Cameron, Bellevue, WA (US); Ahmad Abdel-Wahed, Duvall, WA (US); Matthias Leibmann, Woodinville, WA (US); Kevin Ralph Miller, Bellevue, WA (US); James H. Booth, Barrie (CA); Derek Murman, Redmond, WA (US); Max L. Benson, Redmond, WA (US); Felix W. Wong, Bellevue, WA (US); Cezar Ungureanasu, Sammamish, WA (US)

Correspondence Address: LEE & HAYES PLLC, 421 W RIVERSIDE AVENUE SUITE 500, SPOKANE, WA, 99201, US

(21) Appl. No.: 10/632,521

(22) Filed: Aug. 1, 2003

(51) Int. Cl. G06F 17/00

(52) U.S. Cl. 707/100

(57) ABSTRACT

Subject matter includes a password management system in which a web application obtains a list of accounts associated with a given user from an identity integration system connected to diverse data sources and in which a password can be updated in each data source, even when the identity integration system does not natively communicate with a data source.

### CROSS-REFERENCE TO RELATED APPLICATIONS

The instant application is related to co-pending U.S. patent application Ser. No. 10/434,725, filed May 8, 2003, entitled “Attribute Value Selection for Entity Objects,” by Kim Cameron, Max L. Benson, Matthias Leibmann, Edward H. Wayt, Kevin Miller and James Booth; U.S. patent application Ser. No. 10/435,113, filed May 8, 2003, entitled “Declarative Rules for Metadirectory,” by Kim Cameron, Max L. Benson, and James Booth; U.S. patent application Ser. No. 10/434,726, filed May 8, 2003, entitled “Relational Directory,” by Kim Cameron, James Booth, Matthias Leibmann, Max L. Benson and Mark Brown; U.S. patent application Ser. No. 10/435,720, filed May 8, 2003, entitled “Associating and Using Information in a Metadirectory,” by Max L. Benson; U.S. patent application Ser. No. 10/435,712, filed May 8, 2003, entitled “Preview Mode,” by Kim Cameron, Max L. Benson, Derek Murman, Edward H. Wayt, Jeffrey Bisset, Jie Liu, and Jing Wu; U.S. patent application Ser. No. 10/435,708, filed May 8, 2003, entitled “Rules Customization and Related Methods,” by Max L. Benson, Michael Jerger, Edward H. Wayt, Ken Mark, Kim Cameron, Matthias Leibmann, Jing Wu; and U.S. patent application Ser. No. 10/434,411, filed May 8, 2003, entitled “Automated Information Management and Related Methods,” by Max L. Benson, Stephen Siu, and James Booth; all of which are assigned to the assignee of the present invention, and incorporated herein by reference for all that they teach and disclose.

### TECHNICAL FIELD

This invention relates generally to password management and more specifically to administrative reset of multiple passwords.

### BACKGROUND

To entrust a computing system with confidential personal and financial information requires a user to possess a key or password to the information and a belief that the key or password cannot be copied or guessed. In this regard, passwords have become popular for guarding information, since a password exists itself as information can be formulated for familiarity and easy remembrance without a physical artifact. Passwords are easy to remember without a physical artifact only if they are limited in number. With multiplication of computing and Internet services, it is commonplace to have more than a dozen frequently used online accounts, each requiring a username and password.

To remember usernames and passwords, a user, Nancy M, writes some of her passwords on a slip of paper that she carries in her purse. If the purse is taken, there is still some security in the fact that only she knows that the passwords on are for an online bank account and for an online credit card account. A thief would have to guess her bank name and her credit card company, which might not be difficult depending on the other contents of the purse.

Nancy keeps the passwords and usernames for logging onto other online accounts on slips of paper stuck to her computer monitor. This technique is more secure at home than at work. At home there is a password for a shopping account, a student loan account, an online financial service, a public email account, a PAYPAL® service, and a few other free and subscription services. Password management is more difficult at work. Nancy has her work login credentials memorized, but when she needs to get online for one of the services she usually uses at home she cannot easily remember which password is used with which account. She posted some slips of paper with passwords onto her computer monitor at work, but this did not seem very secure and some of the slips have fallen off spontaneously. Like a person with so many keys the keys are literally falling out of her pockets into the hands of a random finder, Nancy's passwords have gotten out of hand.

Most of Nancy's accounts do not come under a “single-sign” on umbrella, notably her bank account, so the single-sign on solution will not work for her. Besides a couple of her accounts were custom-programmed by the small company she works for and will not likely ever subscribe to a single-sign on service.

### SUMMARY

Subject matter includes a password management system in which a web application obtains a list of accounts associated with a given user from an identity integration system connected to diverse data sources and in which a password can be updated in each data source, even when the identity integration system does not natively communicate with a data source. In example implementations, a user may access an exemplary password management system via a web application, a help desk, or a kiosk application that has access to the identity integration system.

The password management system is capable of calling out for custom logic to connect with a given data source having one of the user accounts, and/or performing custom password management on an account using custom logic, e.g., logic supplied by a user or administrator.

An exemplary password management system allows a data source that does not communicate in the same manner as the identity integration system to maintain its own password management techniques and functions, and uses various methods to gain credentials and/or authority to change or set a new password for a user account on the data source.

In one implementation, an exemplary password management system uses an interface, such as a WINDOWS® MANAGEMENT INSTRUMENTATION (WMI) API, that can be upgraded to provide new password management and identity integration system features without web application designers having to overhaul former versions of the web application. Hence, an exemplary password management system according to the subject matter is extensible and scalable to diverse accounts: via an identity integration system that can connect to heterogeneous data sources; via a flexible interface, such as one or more WMI APIs; via its web application that can be custom-designed because of the flexible interface; and via identity integration system management agents that can perform call outs for custom logic to connect with different data sources and perform custom password management if needed or desired.

An exemplary password management system does not require a piece of proprietary software or hardware to be installed on a connected data source for the connected data source to participate in the password management, as obtaining proper credentials occurs on the identity integration system's server side.

An exemplary password management system does not maintain a store of passwords, only the means specific to each connected data source to manage a password for the data source, thereby resulting in enhanced security.

Password operations can be audited to a centralized repository where an audit record for a password operation tracks a user ID, web applications, management agents, connector objects, and other ancillary data and events associated with the password operation.

### BRIEF DESCRIPTION OF THE DRAWINGS

FIG. 1 is a block diagram of an exemplary configuration of an exemplary password management system.

FIG. 2 is a block diagram of another exemplary configuration of an exemplary password management system.

FIG. 3 is a block diagram of yet another exemplary configuration of an exemplary password management system.

FIG. 4 is a graphic representation of an exemplary password management system in greater detail.

FIG. 5 is a graphic representation of an exemplary password change operation.

FIG. 6 is a graphic representation of an exemplary password set operation.

FIG. 7 is a graphic representation of an exemplary password set operation using custom logic.

FIG. 8 is a graphic representation of exemplary centralized auditing during password management.

FIG. 9 is a flow diagram of an exemplary password management method.

FIG. 10 is a flow diagram of an exemplary method of identifying a user and locating related accounts.

FIG. 11 is a flow diagram of an exemplary method of password resetting using a help desk.

FIG. 12 is a flow diagram of an exemplary method of password changing using a help desk.

FIG. 13 is a graphic representation of an exemplary identity integration system suitable for use with an exemplary password management system.

FIG. 14 is a block diagram of an exemplary identity information management process performable by the exemplary identity integration system of FIG. 13.

FIG. 15 is a block diagram of an exemplary computing device suitable for performing aspects of the subject matter.

### DETAILED DESCRIPTION

Overview

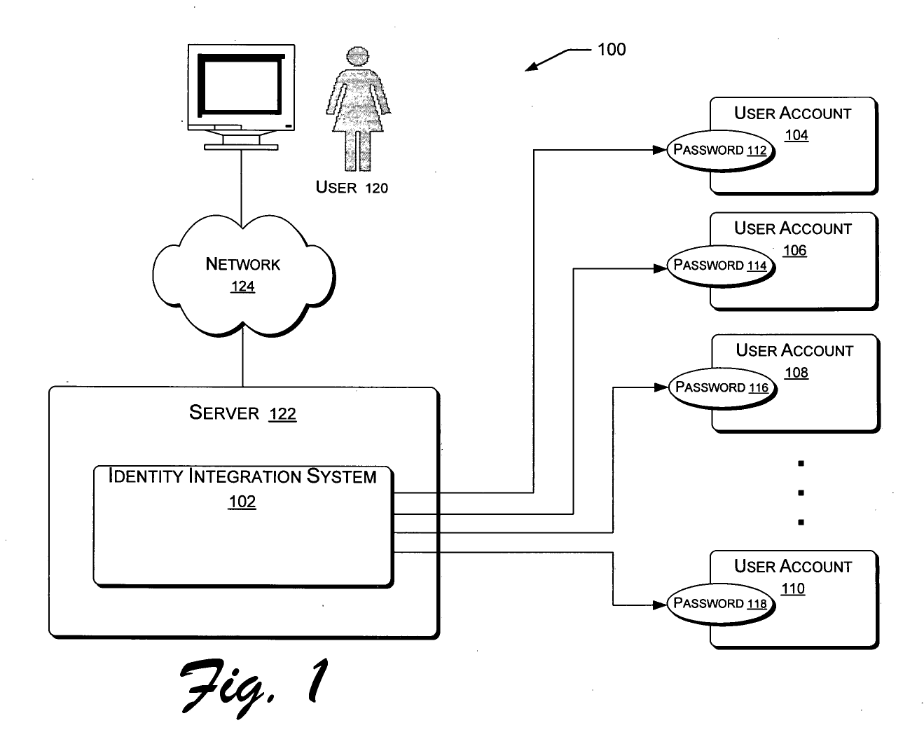

FIG. 1 shows an exemplary password management system 100 for administrative reset of multiple passwords. Administrative reset means that a user's passwords for guarding multiple data sources can be changed, set, and/or reset (“updated”) using joined objects across the multiple data sources, stored in an exemplary identity integration system, to perform password operations.

A password can be a key kept secret by a user for gaining access to an account, and may include combinations of information, so that some “passwords” include a piece of username information with a secret combination of alphanumeric characters. An exemplary password management system 100 enables access to user account information in an identity integration system 102 in order to provide working credential information across multiple, heterogeneous accounts 104, 106, 108, 110 and the ability to globally change or set multiple passwords 112, 114, 116, 118 in those accounts.

As a normal part of the operation of an identity integration system, a great deal of knowledge is built up about users' credentials, i.e., what accounts exist for a given person, where they are located, and sometimes whether passwords can be changed or reset. An exemplary identity integration system 102 has both integrated identity information about a user 120 and their associated accounts and the ability to manage these diverse accounts. However, during synchronization of accounts with the integrated identity information in the identity integration system 102, password information is treated as a special case, due to the security implications. True synchronization of passwords may not be desirable as it creates security risks. However, an exemplary identity integration system 102 according to the subject matter may be able to change or set passwords and ensure the consistency of passwords across multiple heterogeneous accounts.

In one implementation, through an interface, a user 120 or an application can query the identity integration system 102 for a list of accounts that exist for the user 120, and then have the identity integration system 102 automatically change or set the passwords 112, 114, 116, 118.

The subject matter described herein allows changing or setting passwords in many different types of accounts, even accounts that the identity integration system 102 does not natively communicate with. The subject matter performs or requests password management without retrofitting the various types of accounts with an extra agent or an extra piece of software. Passwords for a user's various accounts are not stored in the identity integration system 102, offering no target for malicious access.

The subject matter is extensible, because an exemplary password management system 100 according to the subject matter not only sets a password in a system that the identity integration system does not natively communicate with, but can present interfaces for which a user, administrator, customer, etc. can sometimes write their own custom logic or code. In addition, when features and functionalities are added to an exemplary password management system 100, the added features and functionalities are immediately available to the presented interfaces, so that application developers writing password management applications and/or custom code to interface with an exemplary password management system 100 do not have to immediately update their applications—they can use the same interfaces that they have always used without alteration.

The subject matter is secure, because an exemplary identity integration system 102 does not store passwords on the system and uses secure encryption for communication between the identity integration system 102 and connected data systems. There is no central credential store or password repository that hackers can target.

The subject matter is non-intrusive, because no extra agent or layer of complexity is imposed on pre-existing proprietary password management schemata used by heterogeneous data systems. There is no need to install a piece of password management system 100 software on a server to be included in the password management.

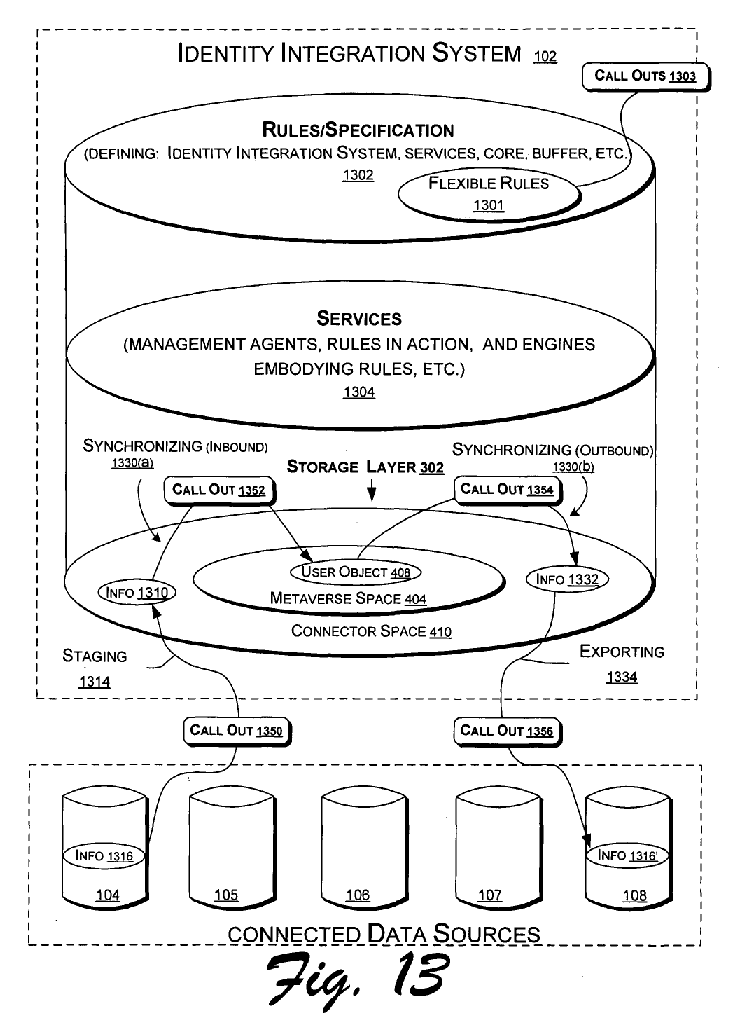

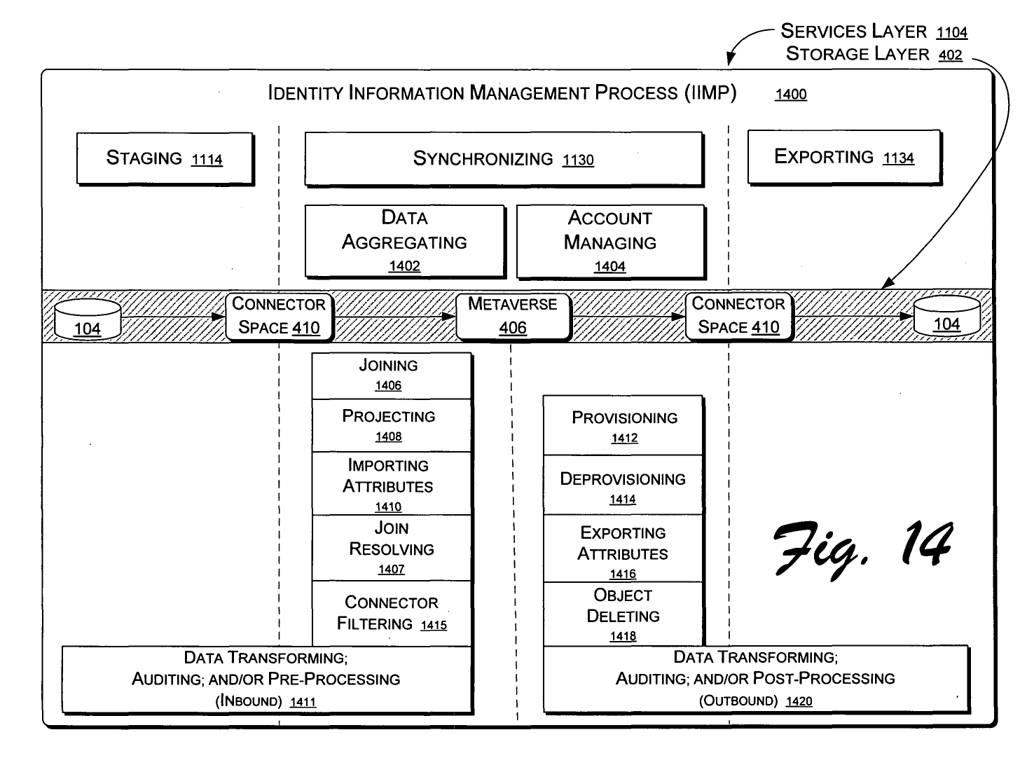

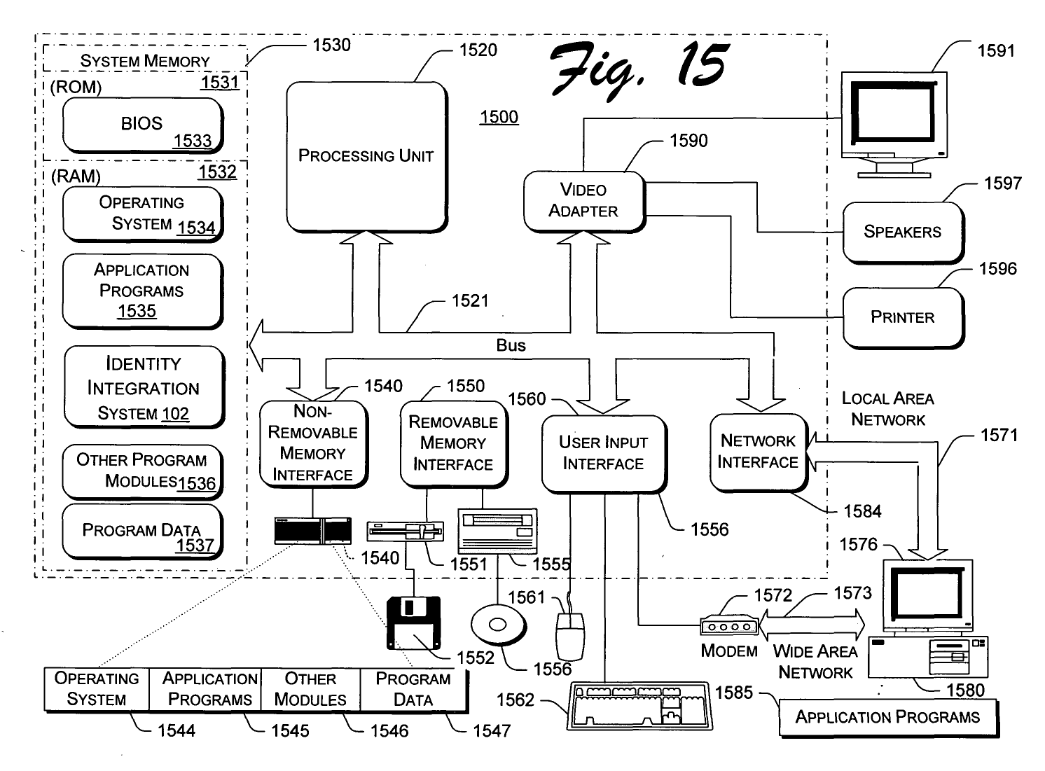

An exemplary identity integration system 102 suitable for performing the password management functions described herein is described below with respect to FIG. 13, while an associated identity information management process (IIMP) performed by the exemplary identity integration system 102 is described below with respect to FIG. 14. A computing device suitable for hosting an identity integration system 102 is described with respect to FIG. 15.

Exemplary Password Management System Configurations

An identity integration system 102 is usually deployed on a server 122 communicatively coupled with a network 124, such as a closed network that uses an available network protocol. In the implementation illustrated in FIG. 1, a user 120 accesses the identity integration system 102 through the network 124, e.g., via a webpage. The user 120 enters appropriate credentials and receives a list of accounts eligible for password management, and selects which accounts are to have passwords managed. The identity integration system 102 takes the user's selections and changes or sets passwords in the various accounts in a manner that depends on the nature of each account.

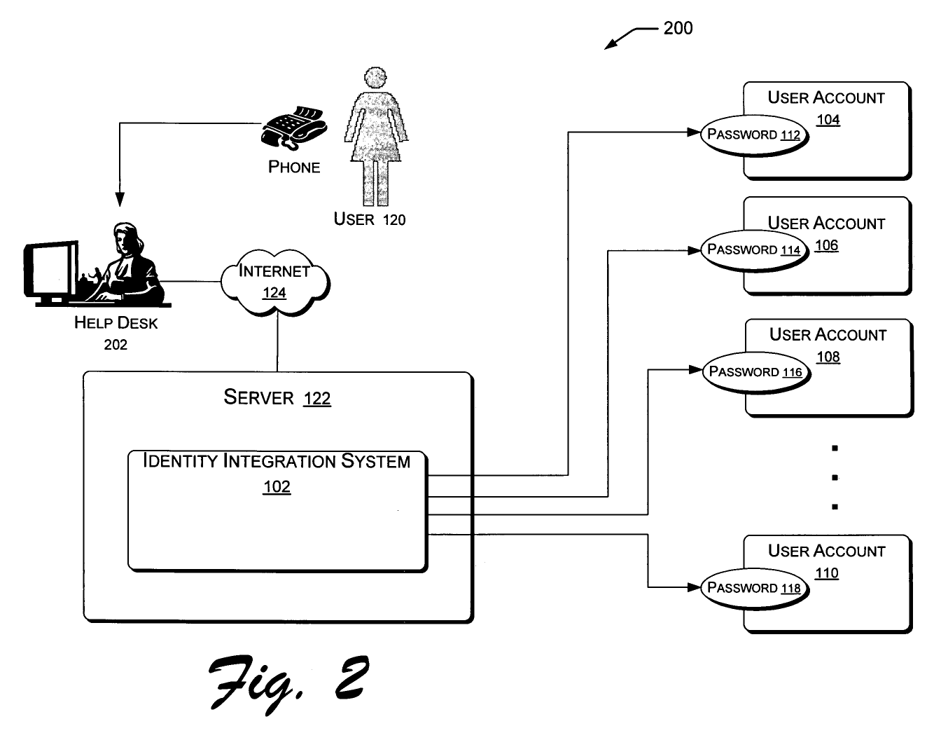

FIG. 2 shows a second implementation of an exemplary password management system 200, wherein a user 120 accesses a help desk 202, for example, by telephone, to begin the process of password management. A support person at the help desk 202 verifies the identity of the user 120 and obtains a list of the user's accounts (e.g., 104, 106, 108, 110) from the identity integration system 102, usually over a network 124. A help desk 202 available by telephone can be useful when a user 120 has forgotten an essential piece of information needed for website logon, or does not have network access. Setting passwords using a help desk 202 will be discussed more fully below with respect to FIG. 15.

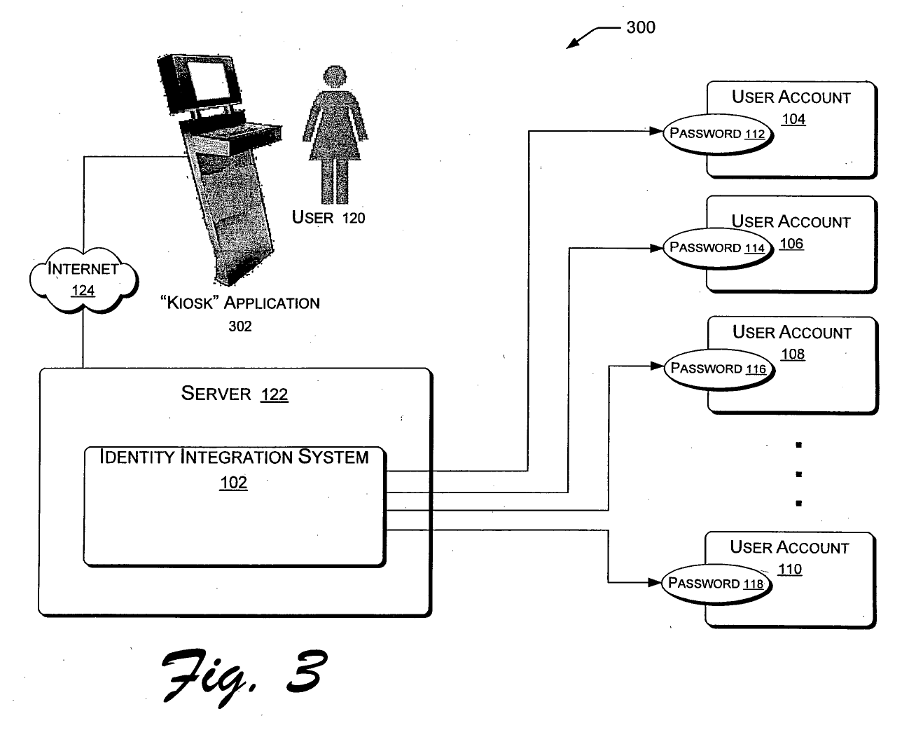

FIG. 3 shows a third implementation of an exemplary password management system 300, wherein a user 120 accesses a “kiosk” application 302 to begin the process of password management. The term “kiosk” is used here as a nickname for a web application that caters directly without the intervention of a help desk to a user who has forgotten his password. Hence, the user 120 interacts directly with the kiosk application 302 but must negotiate access to the identity integration system 102 for resetting passwords by convincing the kiosk application of the user's identity.

In one implementation, the kiosk application 302 presents the user 120 with one or two questions to answer for which the system has stored correct answers. The user 120 has previously told the identity integration system 102 which questions to ask in the event of a lost password and the correct answers and the identity integration system 102 has stored this information in a database. Example questions are “where were you born” and “what was the name of your favorite childhood pet.” The strength of this identity validation method depends on the exclusiveness of the secret information set up previously by the user 120. If the user 120 is able to give the correct answer(s) to the posed question(s), the identity integration system 102 resets the password for the user 120 to a new password selected by the user 120.

The manner in which the identity integration system 102 resets the user's password in the kiosk application 302 differs from the password change application associated with FIG. 1 and described in greater detail with respect to FIG. 14. Since the user's password is unknown, the identity integration system 102 performs password resets using the identity of a privileged user account that the kiosk application 302 is running under. Hence, whereas with the password change application described with respect to FIG. 1 the user 120 provides the actual credentials (a password) for changing passwords, with an exemplary kiosk application 302, credentials to reset passwords are possessed by or accessible by the kiosk application 302 itself, and the kiosk application 302 may extend password management privileges to a user 120 if the kiosk application 302 can come to trust the user 120.

Although the password management systems shown in FIGS. 1-3 use applications and/or help desk personnel to facilitate password management operations, another alternative is using a directory to access the password management capabilities of an identity integration system 102.

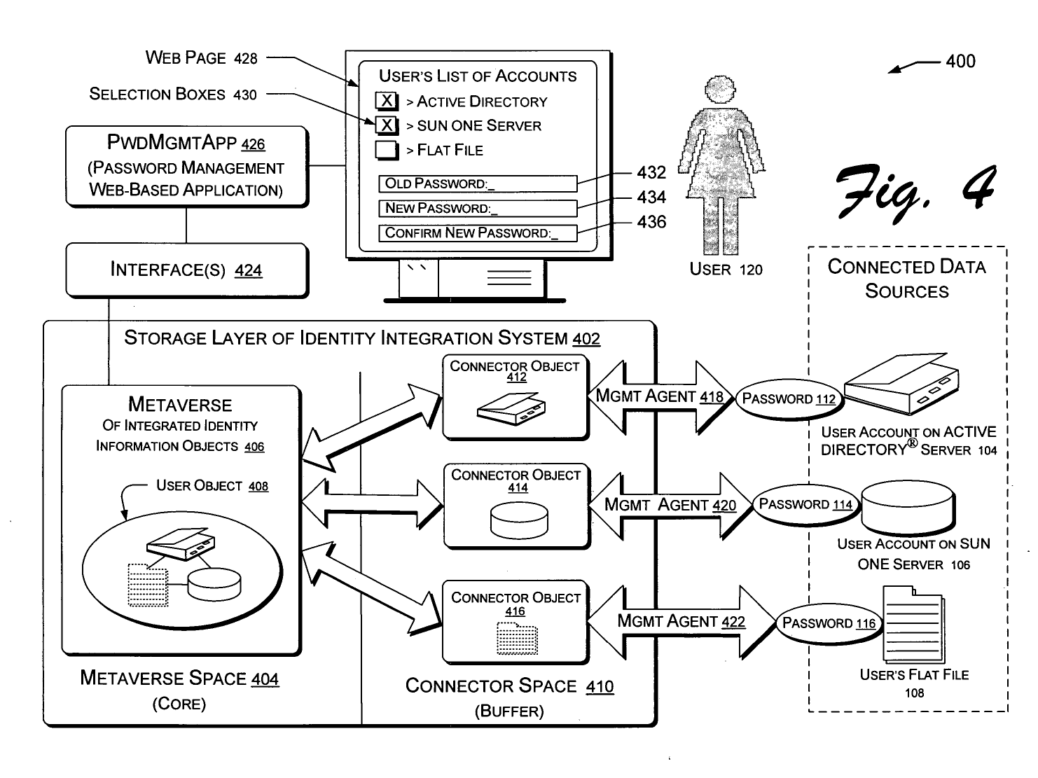

FIG. 4 shows an exemplary password management system 400 in greater detail. A storage layer 402 of an exemplary identity integration system 102 (described more fully below with respect to FIG. 13) includes a metaverse space 404, which is a core storage space that persists integrated identity information, e.g., as a universe of integrated identity objects known as a metaverse 406. The metaverse 406 may include a user object 408 of integrated identity information associated with a user 120. The storage layer 402 also includes a connector space 410, which is a buffer space or staging area for information flowing into and/or out of the metaverse space 404. A connector space 410 may persist connector objects 412, 414, 416, each representing a connected data source (e.g., one of 104, 106, 108) communicatively coupled with the exemplary identity integration system 102.

Each of multiple data sources (e.g., including 104, 106, 108) may differ, e.g., in type and/or platform. Thus, user accounts on one or more ACTIVE DIRECTORY® servers, one or more LOTUS NOTES servers, one or more SUN OPEN NET ENVIRONMENT (“ONE”) servers, one ore more WINDOWS® NT™ servers, one or more NOVELL® EDIRECTORY™ servers, one or more databases, one or more files, one or more metadirectory systems, etc. may be simultaneously connected to or connectable to the exemplary identity integration system 102. A single user 120 may have an ACTIVE DIRECTORY® user account 104 on an ACTIVE DIRECTORY® server, a SUN ONE user account 106 on a SUN ONE server, and a flat file 108 connected or connectable to the exemplary identity integration system 102. A representation of at least a part of each of these data sources (104, 106, 108) may exist as respective connector objects 412, 414, 416 in the connector space 410. The aforementioned user object 408 in the metaverse 406 may include unified, integrated identity information, a “unified view,” of information about the user 120 and the user's associated accounts 104, 106, 108, including a comprehensive listing of the accounts and harmonized information consistent or as consistent as reasonably possible across the multiple accounts, e.g., consistent name, address, age, email address, etc.

In the illustrated exemplary password management system 400, each user account 104, 106, 108 is protected by a corresponding password, that is, each different account may have not only a unique password, but a unique technique, function, and/or schema of setting, changing, and managing its password. Not every user account, however, necessarily has password protection. In one implementation, the integrated identity information in the user object 408 allows a discrimination between password-managed user accounts and user accounts without passwords. In one implementation, the user object 408 does not make this distinction, but a distinction can be drawn from configuration information of management agents (“MAs”) described below.

Each connected data source (e.g., 104, 106, 108) is managed with respect to the exemplary identity integration system 102 by an MA, e.g., one of 418, 420, 422. In the illustrated implementation, each MA (e.g., 418) is configured specifically for its associated connected data source (e.g., 104) since each connected data source may have a different format, platform, use, location, protocol, etc. An MA 418 for managing a user's ACTIVE DIRECTORY® account 104 (e.g., existing on a remote server) may be configured differently than an MA for managing an ACTIVE DIRECTORY® account residing on the same server 122 that hosts the identity integration system 102, and differently than an MA 420 that manages a user's SUN ONE account 106 or an MA that manages a user's LOTUS NOTES account.

Each MA 418, 420, 422 performs connectivity and management between a connected data source (e.g., 104) and the metaverse 406. The user object 408 has pointers to all the different accounts that a particular user 120 has in different systems (i.e., diverse connected data sources 104, 106, 108) and has information about whether the password of each account can be managed via the MA (e.g., 418) configured for that connected data source (e.g., 104). Since the integrated identity information in the user object 408 has information about these diverse accounts, the webpage 428 can display with respect to each user 120, which accounts can have passwords managed on them.

In one implementation of the subject matter, an exemplary server 122 running and/or participating in an exemplary identity integration system 102 exposes one or more interfaces 424, such as one or more widely available MICROSOFT® WINDOWS® MANAGEMENT INSTRUMENTATION (WMI) application program interfaces (APIs). An exemplary web-based password management application (“PwdMgmtApp”) 426 uses the exposed interface(s) 424, e.g., via a webpage 428, to perform and/or to allow a user 120 or help desk (202) support person to perform password management of multiple heterogeneous user accounts (e.g., 104, 106, 108) through an exemplary identity integration system 102. In other words, an exemplary identity integration system 102 provides an underlying engine or “plumbing” that powers or carries out many of the password management processes.

If an exemplary password management system 400 and/or server 122 is implemented as a MICROSOFT® IDENTITY INTEGRATION SERVER (“MIIS”) product, the interface(s) 424 can be one or more WMI APIs as described above. The WMI capabilities are fully documented in help files that ship with versions of MIIS. A third-party application developer can freely design various exemplary PwdMgmtApps 426, each of which can use an exemplary identity integration system 102 through a WMI interface 424.

In one implementation, an exemplary PwdMgmtApp 426 has the capacity to query the identity integration system 102 to find a user object 408 in the metaverse 406 corresponding to the user 120. As mentioned, the integrated identity information in the user object 408 includes information from which a list of user accounts 104, 106, 108 for a user 120 can be derived, as well as information that allows the PwdMgmtApp 426 to list only those accounts eligible for password management. The PwdMgmtApp 426 presents a list of accounts to the user 120, usually with a means for selecting one or more of the displayed 11 accounts, such as selection boxes 430. In one implementation, the PwdMgmtApp 426 also prompts the user 120 for an old password 432 or other credential information verifying the user 120, and prompts the user 120 for a new password 434, and perhaps a confirmation 436 of the new password 434. The PwdMgmtApp 426 collects the user's account selections and new password 434, and informs an exemplary identity integration system 102 to change or set the passwords on the selected accounts to the new password 434.

How an exemplary identity integration system 102 changes or sets pre-existing passwords (e.g., 112, 114, 116) on selected accounts to a new password 434 varies because of the heterogeneous nature of the different connected data sources 104, 106, 108. Each connected data source may require a different treatment. However, an exemplary identity integration system 102 is already equipped via the MAs 418, 420, 422 to manage different connected data sources 104, 106, 108 in a manner that best suits each connected data source.

Since an exemplary identity integration system 102, which may be thought of as an engine underlying an exemplary password management system 400, can manage diverse connected data sources 104, 106, 108 on the server side of server-client relationships (e.g., via call-outs for custom logic supplied by an administrator of a connected data source), an administrator or organization may extend password functionality to many kinds of systems.

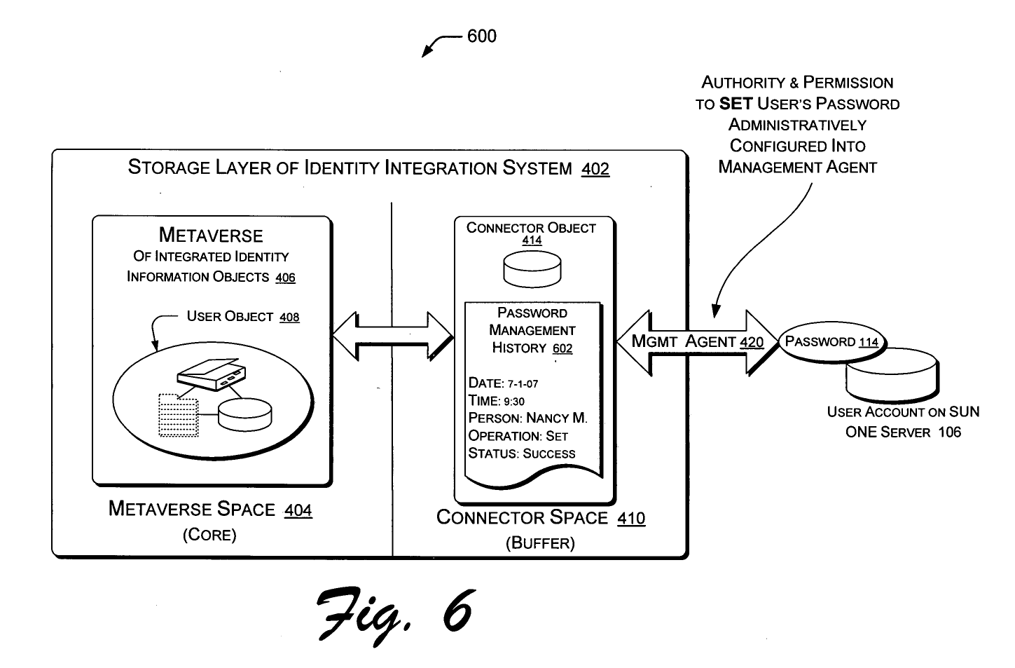

An organization using an exemplary password management system 400 can implement their own password management features in a very scoped and manageable way: if there is an MA (e.g., 418) that is provided with an exemplary identity integration system 102 to manage a certain type of connected data source (e.g., 104) and the MA 418 is inherently amenable to password management, the organization may use the provided MA 418. For a connected data source that uses an MA 422 that does not inherently support password management, such as an MA 422 for a flat file 108, an organization that wants to provide password management for the flat file 108 may do so, and may also do so for each object to be managed in the flat file 108. In other words, an exemplary password management system 400 can use a custom logic call-out feature of an exemplary identity integration system 102 to set a password in a connected data source 108 that an exemplary identity integration system 102 does not natively communicate with. This will be discussed in more detail below, with respect to FIG. 6. Thus, an exemplary identity integration system 102 product may not be able to communicate “out of the box” (natively) with every kind of system an organization might want to include in password management, but can use calls for custom logic to do so, providing an exemplary password management system 400 with unlimited extensibility. If the exemplary identity integration system 102 is a version of MIIS, an administrator familiar with producing one kind of custom rules extension can extend password management to diverse connected data sources through the same kind of custom rules extension without having to learn new functions or features.

From an infrastructure aspect, designers of exemplary PwdMgmtApps 426 used with a MIIS product do not have to retool each time an exemplary identity integration system 102 as changes versions, because integration of new features and functionality on the server side is immediately available to WMI API interface(s) 424. That is, an application developer does not have to accommodate new components and broader password management scope as versions progress, since this is done automatically while the application developer uses the same interface as before. A software developer can develop logic to manage passwords and/or to display a set of accounts to a user using an exemplary interface 424, and if an exemplary identity integration system 102 being used with the exemplary interface 424 is upgraded with new features, (e.g., additional MAs for managing passwords), the software developer does not have to revisit and rewrite the former application as the former application will already be making correct interface calls. So without writing additional code, the software developer will automatically receive enhanced functionality because of the way the one or more exemplary interface(s) 424 are used.

Exemplary Password Management of Diverse Accounts

An exemplary password management process can use, at least in part, an exemplary identity information management process (IIMP) 1400 (performed by an exemplary identity integration system 102) described below with reference to FIG. 14. An exemplary password management process may be described from a user's point of view, as described in the following example scenarios.

In one implementation, a user, “NancyM”, wants to change passwords in some of her many different accounts. She has, among others, a primary ACTIVE DIRECTORY® account in the Milkyway domain, a LOTUS NOTES account, and an account on a SUN ONE server. She has been keeping her various passwords on small pieces of paper and sticking these to her computer monitor. However, she is becoming worried about the usefulness of this system as the passwords and usernames have multiplied and some of the pieces of paper have fallen off and could be lost. She cannot always remember which password goes with which account. Other people could also come into her office, see the passwords, and try to crack her accounts by using informed guessing techniques.

To use an exemplary password management system 400 in this implementation, Nancy logs onto a primary account and types in a uniform resource locator (URL) to an exemplary webpage 428 generated by an exemplary PwdMgmtApp 426. The PwdMgmtApp 426 has logic to determine that Nancy is logged in as NancyM (her username) in the Milkyway domain, and displays for Nancy a list of accounts from an exemplary identity integration system 102 underlying the exemplary password management system 400 used by the PwdMgmtApp 426. For example, the webpage 428 could display, among others, her ACTIVE DIRECTORY® account 104 in the Milkyway domain, her account in NOTES, and her SUN ONE account 106.

Described in greater detail, in order to display a list of Nancy's user accounts, an exemplary PwdMgmtApp 426 has the capacity to communicate with the exemplary identity integration system 102, sending a message that could be paraphrased as “Milkyway NancyM is logged in right now, please return a list of her accounts amenable to password management.” The exemplary identity integration system 102 executes a query, finds Milkyway NancyM, then finds her user object 408 in the metaverse 406, also finds her accounts 104, 106, 108, and then sends information back to the exemplary PwdMgmtApp 426 indicating whether or not each account can be managed with a password. An exemplary PwdMgmtApp 426 makes a determination of whether an account can be managed with a password based on different kinds of accounts available and based on different kinds of objects managed in different kinds of systems. In this case, Nancy's three accounts are ones on which password management can be performed. She might have several different objects represented in the metaverse 406 that are not amenable to password management, a circumstance that an exemplary identity integration system 102, such as an MIIS product, can test for.

In one implementation, an exemplary PwdMgmtApp 426 has a configuration setting (that an administrator can control) that determines whether or not Nancy can select or unselect accounts that she wants to change and/or set passwords on. In the present case, an administrator has decided Nancy may select which accounts she wants to manage passwords on, so in one implementation Nancy chooses a “select all” option, types her old password, types a new password, types the new password again for confirmation, and clicks her mouse on a “change my password” button. An exemplary PwdMgmtApp 426 establishes whether or not servers that are going to receive the new password are operational and communicating (i.e., “up”) at that very instant, and (based on an optional PwdMgmtApp 426 configuration setting) if all servers are up, the PwdMgmtApp 426 attempts to perform the password operation proper to each server. If certain servers are down, e.g., if the Milkyway server (on which she logged in) is down, an exemplary PwdMgmtApp 426 can be configured so that no password operations will be attempted because the main server is down. If all respective servers are up and available, an exemplary PwdMgmtApp 426 may have another configuration option that allows non-secure password management—i.e., password management using MAs not configured to communicate with their respective connected data sources using a secure communications protocol. In the present example, an administrator decides NOT to allow non-secure password management. In one implementation, therefore, Nancy's three accounts appear in the account list because all three are reached securely, as determined by an exemplary PwdMgmtApp 426. When an exemplary PwdMgmtApp 426 checks to see if server connections are all available (checks to see if servers are up), it may also check to make sure the servers are all still secure.

When an exemplary PwdMgmtApp 426 determines that all relevant servers are up and that they are all reachable securely, then depending on the type of connected data source, an exemplary PwdMgmtApp 426 performs either a change password or a set password operation on each account returned in the user's list of accounts on the webpage 428.

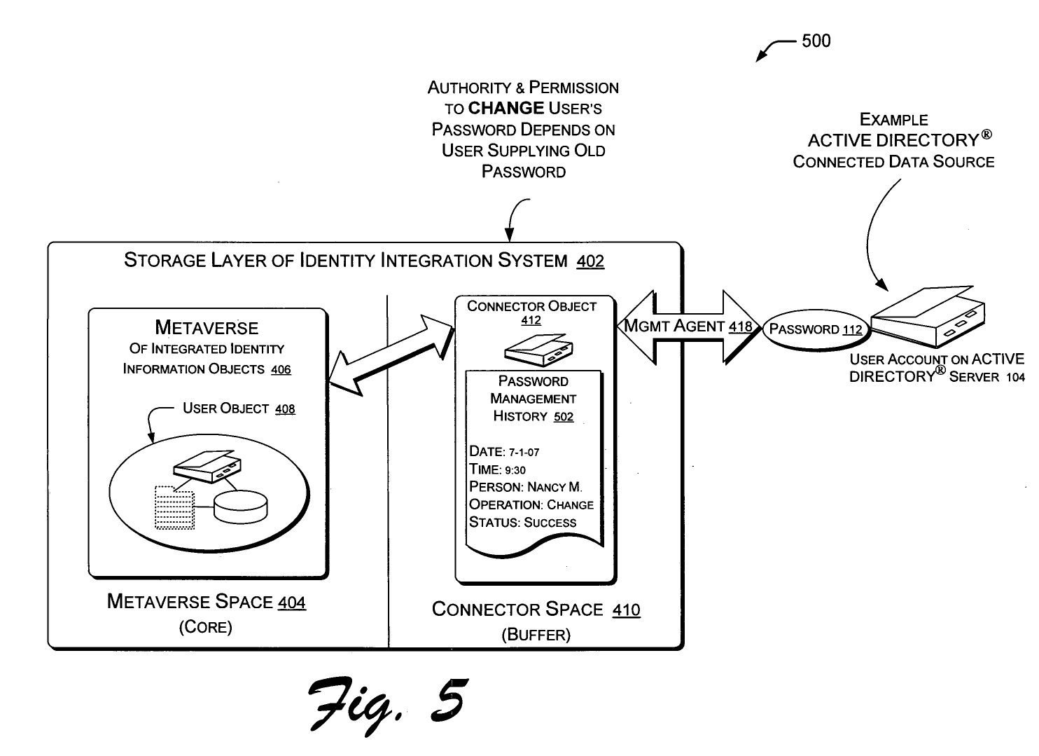

FIG. 5 shows an exemplary password management operation 500 in a first user account displayed for a user on the exemplary webpage 428. Nancy M's Milkyway account is an ACTIVE DIRECTORY® account 104 that supports a password change, as opposed to only a password set. If Nancy has logged on using her username and has entered her old password 432 and a new password 434, then an exemplary identity integration system 102 may push her old and/or new password 434 in real-time to domain controllers for a password change, for example, through a Kerberos change password function call. (Because Nancy is changing her old password, a Kerberos change password function typically does not require escalation of privilege in order to be called, only the old password is required to set a new password.) It should be noted that the credentials and/or authority for making a password change associated with her ACTIVE DIRECTORY® account 104—how the identity integration system 102 verifies that it is really Nancy M trying to change the password—are inherent in the success or failure of the change password call, rather than by trying to authenticate Nancy's credentials stored in the metaverse 406. This prevents the metaverse 406 from becoming a credential store, which would be a security risk. The exemplary identity integration system 102 returns a status for each operation in each account to the webpage 428.

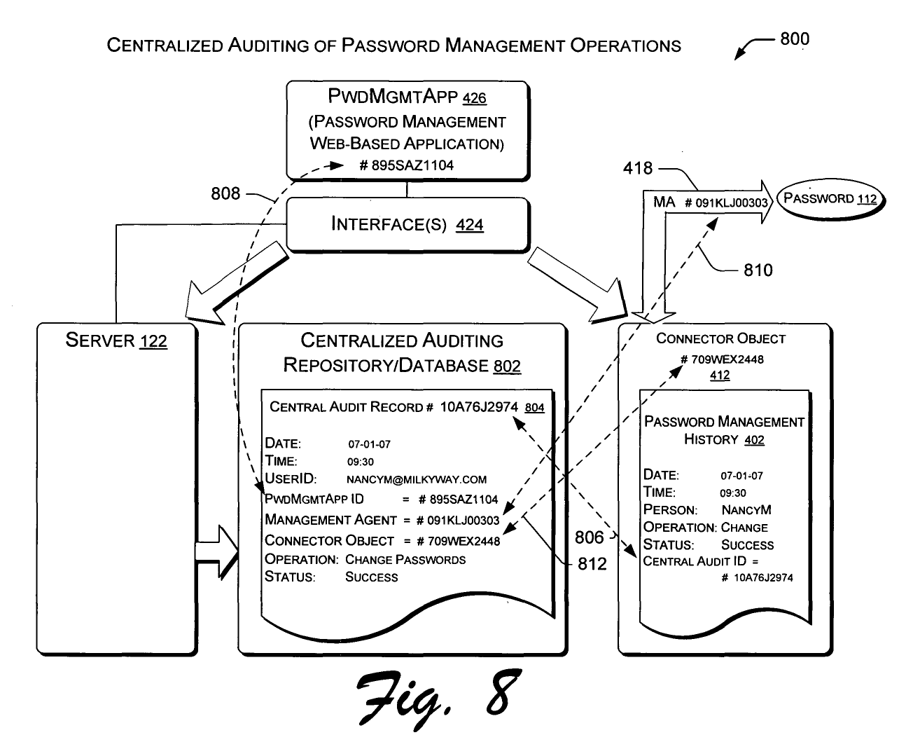

In one implementation, a password management history 502 is also written to a connector space 410 of the identity integration system 102, and typically kept in a connector object 412 associated with Nancy's ACTIVE DIRECTORY® account 104. The password management history may log such items as date and time of a password management operation, a person associated with the operation, the type of operation (e.g., password change or set), and the status of the operation (e.g., success or failure). A centralized auditing record may also be kept of a password management operation, as will be discussed more fully below with respect to FIG. 8.

FIG. 6 shows a password management operation 600 on the next account 106 returned in the user's list of accounts displayed in the webpage 428. Nancy's SUN ONE account 106 is managed by an MA 420 that does not support a password change operation. But the password for the SUN ONE account 106 can still be managed using an administrative password set operation. An exemplary identity integration system 102 can use credentials configured in an MA 420 that communicates with the SUN ONE account 106, such as an administrator user-ID that has the appropriate permissions to set a password for Nancy's SUN ONE account 106. When an administrator first configured the MA for the account 106 the administrator supplied credentials having the appropriate permissions to do a “set password” function. That is, prior to Nancy's logon, an administrator has configured the MA 420, entered correct credentials, enabled password management, e.g., as an option checkbox in an MA configuration environment, and has verified that information about Nancy's account 106 is actually joined to entries in her user object 408 in the metaverse 406, for example, by running a synchronization engine.

Using the administrator credential(s) configured in the MA 420, Nancy's password is reset to its new value. Like Nancy's ACTIVE DIRECTORY® account 104, a connector object 414 for Nancy's SUN ONE account 106 may have a password management history 602 that includes such items as date and time of a password management operation, a person associated with the operation, the type of operation (e.g., password change or set), and the status of the operation (e.g., success or fail).

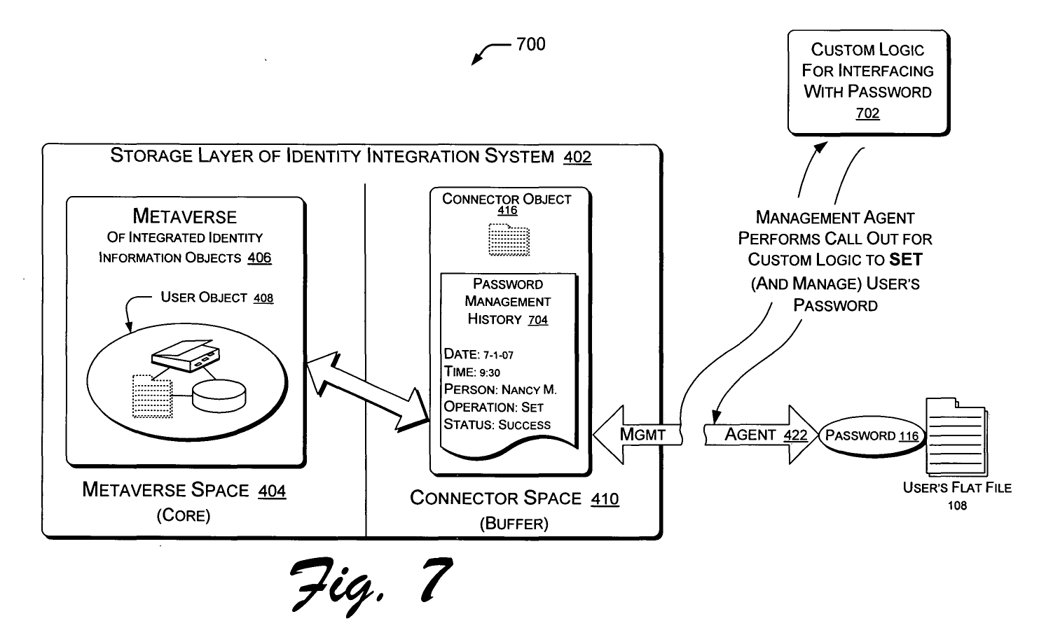

FIG. 7 shows a password management operation 700 on the next account 108 returned in the user's list of accounts in the webpage 428. Nancy's flat file 108 is managed by an MA 422 that does not support a password change operation and requires custom logic 702 supplied by an administrator of the data system on which the flat file resides in order for the MA 422 to communicate with the flat file 108 and perform password management. An exemplary password management system 400 may provide an interface for an MA to call for custom logic, as will be described in greater detail with respect to FIG. 13. The custom logic 702 permits connection, for example, to a mainframe computer, a UNIX or VAX system, etc. and/or permits custom password management.

Like Nancy's ACTIVE DIRECTORY® account 104 and her SUN ONE account 106, a connector object 416 for Nancy's flat file 108 may have a password management history 704 that includes such items as date and time of a password management operation, a person associated with the operation, the type of operation (e.g., password change or set), and the status of the operation (e.g., success or fail).

The exemplary webpage 428 receives back from the exemplary identity integration system 102 all the statuses of the password management operations performed on her accounts 104, 106, 108 and depending on configuration options may display for Nancy a connection status of each server associated with each account 104, 106, 108, whether each connection is secure, and a status of each password change or set operation.

In a second implementation, Nancy has forgotten her password and phones a help desk 202. By being able to look at information that is available about Nancy internally, a person at the help desk verifies that the caller is Nancy M., e.g., because the user knows meta-password type information (place of birth, name of Nancy's pet, etc.). Based on verification, the help person goes to an exemplary PwdMgmtApp 426 to perform password setting. The help desk person might ask Nancy what her main login account is, in this instance, her Milkyway ACTIVE DIRECTORY® account 104. The help desk person may then search for Milkyway Nancy M and the exemplary PwdMgmtApp 426 queries the identity integration system 102 to find out if it recognizes Milkyway Nancy M and what accounts she has. The webpage 428 viewed by a person at the help desk 202 can be the same as the webpage 428 viewed by Nancy when Nancy herself logged into the exemplary password management system 400 in the previously described implementation.

Once the user's list of accounts is available, the password management process as administered by the help desk person is almost the same as when Nancy herself logged onto the webpage 428, with the exception that when an exemplary PwdMgmtApp 426 decides to manage Nancy's password on her ACTIVE DIRECTORY® account 104, since she has forgotten her password to that account, the exemplary PwdMgmtApp 426 relies on administrative credentials in the associated MA 418 to perform an administrative reset of her password 112, rather than a change of the password 112 (assuming her account 104 is in a domain and/or forest subject to permissions configured in the MA 418).

In one implementation, an exemplary password management system 400 does not check different strengths of password policy that administrators can set in different systems hosting different types of accounts 104, 106, 108. In one implementation, an exemplary identity integration system 102 assumes that a primary account is in a forest that has the most stringent password policy and does not implement a password policy checking function on a server 122. In an alternative implementation, an exemplary password management system 400 implements a password policy checking function for each system hosting a user account (e.g., 104, 106, 108). In one implementation, an exemplary password management system 400 exposes a user interface for an administrator to define what an operative password policy will be, and the administrator can define a password policy once in the exemplary identity integration system 102 and then for different connected systems. If such a password policy is consistently enforced, it reduces an amount of administrative overhead required to maintain consistent password policy.

FIG. 8 shows exemplary centralized auditing 800 of password management operations, providing a supplement or an alternative to the storing of a password management history 502 on a connector object 412 associated with a particular user account that was described above.

An exemplary centralized auditing operation 800 stores details of a password management operation in a centralized auditing repository and/or database 802. In one implementation, a central audit record 804 is more centrally available and more comprehensive in recorded details and links to details about a password operation than a password management history 502 stored with a connector object of a particular user 120. A central audit record 804 may correlate a password update operation with many pieces of information about the operation: the PwdMgmtApp 426 that triggered the password update; the userID associated with the operation; management agent(s) 418 affected and/or updated by the operation; connector objects 412 associated with the operation, etc.

In one implementation, each password set or change operation is stored as a record in the centralized log as opposed to making pointers to management agents 418. That is, a record for each password operation performed on each connected data source is kept independently. Of course, there are many various ways of laying out data in a centralized logging and/or centralized auditing repository/database 802 that those skilled in the art would easily be able to devise.

In one implementation, when a password management application, such as an exemplary PwdMgmtApp 426, is about to set or change a password, the application makes a call, e.g., via an interface 424 such as WMI, to a server, for example server 122, to log the initiation of a password set or change operation giving such information as tracking pointers (e.g., tracking GUIDs 808, 810) for correlation of the related set and change operations on different management agents 418; a user ID such as “NancyM” associated with the current password management operation; and its own identity, that is, the identity of the calling PwdMgmtApp 426. The server 122 then logs this information to a centralized auditing location, such as the centralized auditing repository/database 802 together with ancillary information such as date and time of password management occurrence, success or failure, errors generated, etc.

When the application, such as PwdMgmtApp 426, makes the call(s) to the server 122 to set, reset, or change a password on a particular connector object 412, one or more tracking GUIDs (e.g., GUID 806) can be included in the connector object history (e.g., 502) together with other details of the operation. An implementation of the interface 424 (e.g., WMI) called in the server 122 logs information about each password set or change to the centralized auditing repository/database 802 together with the date, time, tracking GUID(s), identifier of management agent 418, identifier of the connector object 412, etc. The central audit record 804 may be laid out in many different ways. For example, a central audit record 804 may be kept for multiple password operations resulting from a single user request, in which the central audit record 804 tracks management agents 418. Alternatively, separate central audit record 804 may be kept for each individual password set or change operation for each single data source or user account. This latter more microscopic approach may be useful for some types of audit analysis in which each password set or change operation needs to appear more empirically as an individual password operation. The centralized auditing repository 802 can then be consulted and statistical performance and error studies, etc., can then be performed on the central audit records 804 for numerous individual password operations. Persons having ordinary skill in the arts of database layout and data auditing will appreciate that there are many ways of laying out data in a centralized logging and/or centralized auditing repository/database 802 and in central audit records 804.

The various tracking pointers, when used, such as GUIDs 806, 808, 810, 812, create strong central audit records 804 with cross-linkage between applications 426, management agents 418 if tracked, connector objects 412 if tracked, and the various other data recorded in relation to a particular password operation.

Exemplary Methods of Password Management

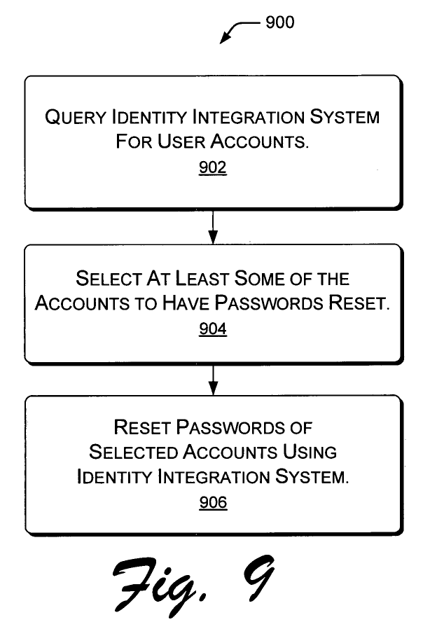

FIG. 9 shows an exemplary password management method 900 according to the subject matter. In the following flow diagram, the operations are summarized in individual blocks. The operations' may be performed in hardware and/or as machine-readable instructions (software or firmware), e.g., that can be executed by a component of an exemplary password management system 400.

At block 902, an identity integration system is queried for user accounts.

At block 904, at least some of the user accounts are selected to have their passwords changed or set.

At block 906, the identity integration system changes or sets passwords of the selected accounts.

Different implementations of an exemplary password management process (e.g., a user self-service method and a help desk-assisted method) may use similar process segments to achieve their goals. In some implementations an exemplary password management process may use a “user-identification/account-location” segment and a subsequent “password change or set” segment, as described below.

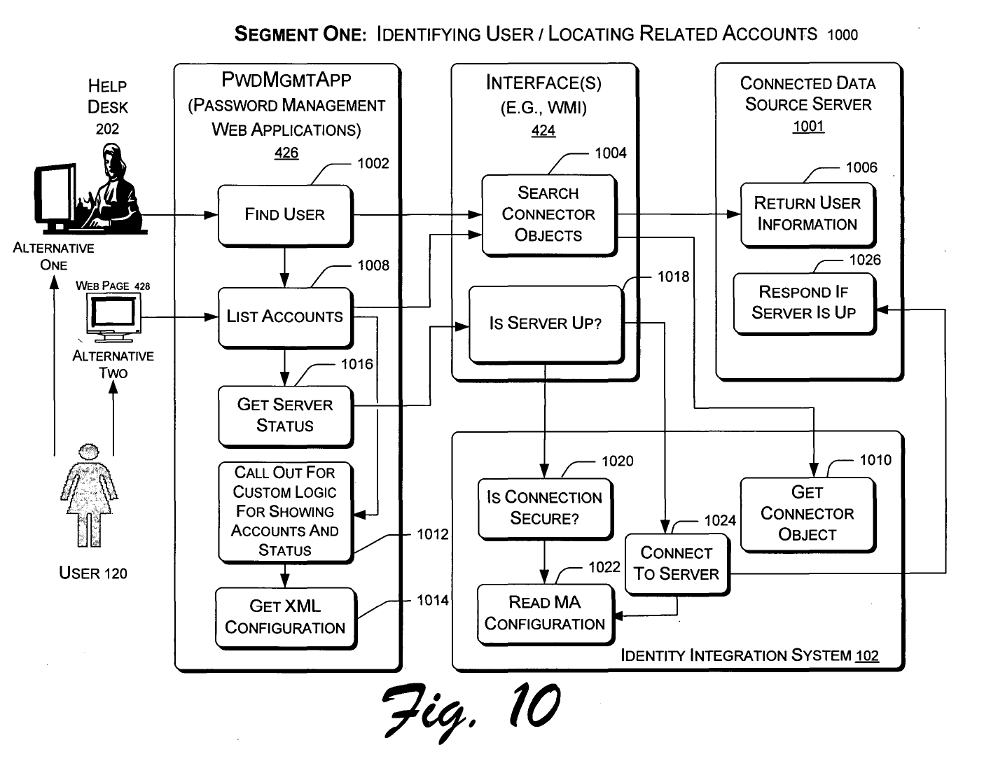

FIG. 10 shows an exemplary first segment of a password management process: a user-identification and/or account-location method 1000. In the following flow diagram, the operations are summarized in individual blocks. The processes in the flow diagram can be performed by example components in an exemplary password management system 400. Thus, the operations may be performed in hardware and/or as machine-readable instructions (software or firmware), e.g., that can be executed by a component of the exemplary password management system 400. The illustrated exemplary method 1000 describes at least in part interactions between a user 120, an exemplary PwdMgmtApp 426, an exemplary identity integration system 102, and exemplary interface(s) 424. In one implementation, the exemplary method 1000 is performed by components of an exemplary MIIS identity integration system.

The illustrated segment of a password management process involves locating data required to actually change or set a password in a subsequent operation. Thus, no data is actually changed in an exemplary identity integration system 102 or in a connected data source during this segment.

Identifying a User

A user 120 initiates an action in one of two ways. The first way is by calling a help desk 202 to ask a support person for a password reset. The help desk person may use a password set application, such as an exemplary PwdMgmtApp 426, to perform this operation at the user's request. The support person at the help desk 202 first asks the user 120 to give their user ID (e.g., username, universal principal name (UPN), or user login name) and domain name to verify the identity of the user 120. The help desk support person might also ask a series of questions to verify identity (this part of the process is external to an exemplary PwdMgmtApp 426 but in one implementation could be included in an exemplary PwdMgmtApp 426).

At block 1002, the support person at the help desk 202 finds user information in the identity integration system 102 using the PwdMgmtApp 426. In order to be allowed to perform this search, a help desk support person's user ID (e.g., username, user principal name (UPN), user login name, etc.) may have to belong to a special security group that grants permission to search connector objects (e.g., 412, 414, 416) and perform administrative password resets. If the help desk support person has the correct group membership or other validations, then the process proceeds as follows.

At block 1004, a password set application, such as one belonging to an exemplary PwdMgmtApp 426, may use an exemplary identity integration system's interface(s) 424, such as a WMI interface, to perform a search of connector objects 412, 414, 416 for the user's account(s), typically by means of the user's user ID and domain name.

At block 1006, this search determines if the user's accounts are validly accessible by communicating directly with a connected data source server (e.g., 1001) to get a user account identifier which in one implementation can be either an ACTIVE DIRECTORY® globally unique IDentifier (GUID) or a WINDOWS® NT system identifier (SID). This identifier, which is an anchor in the connector space 410, is then used to obtain a user connector space object 412 from the exemplary identity integration system 102. If successful, the user's accounts are found to be validly accessible in the connected data source server 1001 and in the exemplary identity integration system 102 and the user's identity is considered to be verified.

As mentioned above, a user 120 may initiate action in a second manner, by navigating directly to a password change application, such as one included in a PwdMgmtApp 426. In this case, the exemplary PwdMgmtApp 426 determines the user's ID and domain name (the web server can determine the credentials of a user 120 who is logged in) and at block 1002 attempts to find user information in the identity integration system 102. The exemplary PwdMgmtApp 426, when installed on the web server, is configured to use a special credential, known as the application pool identity. Just as a support person at a help desk 202 needs a group membership in order to be able to find a user's account, the application pool identity must have the right group membership in order to be able to find a user's account.

Locating a User's Accounts

At block 1008, to find related accounts to list on the webpage 428, when the user's credentials are authenticated and validated, either by the help desk person using an exemplary PwdMgmtApp 426 or by the exemplary PwdMgmtApp 426 itself, both a password change and a password set application function in the same way to find a user's related accounts (e.g., 104, 106, 108). The process of listing accounts uses all the illustrated components of an exemplary password management system 400 shown in FIG. 10. The user account (e.g., 104) found at block 1004 has a connector space GUID and a metaverse GUID. Another search of the connector space 410, e.g., via a WMI interface 424 using the metaverse GUID, is performed to retrieve a list of accounts (see webpage 428) that are related to the user 120.

At block 1010, the search will return at least one object (e.g., 412). For each object returned, the search also returns information about the MA (e.g., 418) associated with the object 412. This information includes a property value or bit that indicates whether or not the MA 418 is capable of password management, and another property value or bit that indicates whether or not the MA 418 has been configured to allow such password management operations. Yet another property value or bit indicates whether or not the MA 418 is configured to use a secure communication protocol.

At block 1012, the display of accounts can be altered based on user-extensible call outs and/or callbacks for which a user 120 or customer can provide code written (in one implementation) in a programming language such as VISUAL BASIC .NET™. At block 1014, these call outs and/or callbacks determine how to interpret, for example, an XML file that stores configuration information that determines the behavior of the PwdMgmtApp 426. The XML configuration options may include a list of object types in each connected data source 104, 106, 108 for which password management is valid.

At block 1016, depending on configuration options, whether or not objects returned to the account list are displayed in a webpage 428 can also depend on the status of the connected data source server 1001. The account listing process at block 1008 determines server status at block 1016 in the following manner. Each connector object (e.g., 412) returned to the account list at block 1008 includes a GUID that determines the MA 418 that manages it. In one implementation, at block 1018, a WMI object class, such as “MIISManagementAgent” has an “IsServerUp” function that informs a calling process whether or not a connected data source server 1001 is operational and communicating, i.e., “up,” and whether or not the connection is secure. This function performs the following actions.

At block 1020, the above-mentioned IsServerUp function calls the connected data source server 1001 to determine if the connection to the connected data source server 1001 is secure. At block 1022, in order to make this determination, the configuration of the MA 418 that manages the connected data source 104 on the connected data source server 1001 is examined.

At block 1024, the IsServerUp function then tries to connect to the connected data source server 1001, e.g., using the MA's “initialize” routine. The connection is attempted and at block 1026 the connected data source server 1001 will respond if operational and communicating, i.e., up and running.

The accounts actually displayed at block 1008 on a webpage 428 may depend on: the status of a connected data source server 1001; the object type of each connector object 412, 414, 416 returned at block 1008; whether non-secure connections are to be excluded from the list; whether custom customer user-defined logic is implemented in callouts and/or callbacks, etc. An exemplary PwdMgmtApp 426 displays accounts and status on the webpage 428 for those accounts that fit the configuration options.

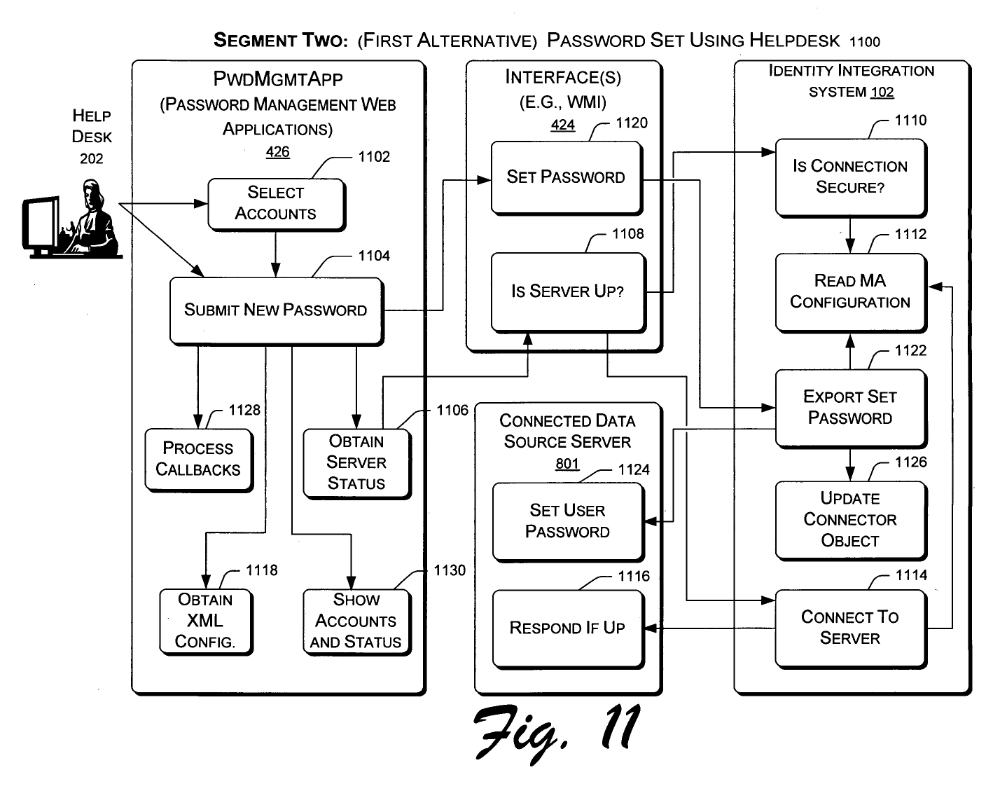

FIG. 11 shows an exemplary password set method 1100 using a help desk 202 that can be employed as a second segment of a password management process that uses the exemplary first segment described above with respect to FIG. 10. In the following flow diagram, the operations are summarized in individual blocks. The processes in the flow diagram can be performed by example components in an exemplary password management system 400. Thus, the operations may be performed in hardware and/or as machine-readable instructions (software or firmware), e.g., that can be executed by a component of the exemplary password management system 400. The illustrated exemplary method 1100 describes at least in part interactions between a user 120, an exemplary PwdMgmtApp 426, an exemplary identity integration system 102, and exemplary interface(s) 424. In one implementation, the exemplary method 1100 is performed by components of an exemplary MIIS identity integration system.

At block 1102, a support person at a help desk 202 selects one or more user accounts for password setting, usually at a user's prompting. The support person typically peruses an account list generated in a first segment of a password management process such as that described above with respect to FIG. 10. If configuration options allow selection of user accounts being displayed then a support person at a help desk 202 can ascertain from a user 120 which accounts to select and deselect for password management.

At block 1104, the help desk support person either generates a new password using an external tool, or asks the user to provide one and types the new password into an exemplary PwdMgmtApp 426. The help desk support person then submits the new password.

At block 1106, an exemplary PwdMgmtApp 426 determines a status of a relevant connected data source server 1001. Since the account list that the help desk support person used for selecting user accounts at block 1102 contains enough information from connector objects 412, 414, 416 to perform password resetting, there is no need to perform any additional search (e.g., using WMI) to find objects. Each connector object 412, 414, 416 has an MA GUID property.

As block 1108, in one implementation a WMI object class, such as “MIISManagementAgent” includes an “IsServerUp” function that calls an exemplary identity integration system 102 to ascertain whether or not a connected data source server 801 is operational and communicating, i.e., “up,” and at block 1110 whether or not the connection with the connected data source server 801 is secure, that is, the IsServerUp function reports on the state of the connection between the identity integration system 102 and a connected data source 104.

At block 1112, in order to make the above determination, a configuration of the MA 418 that manages the connected data source 104 on the connected data source server 801 is examined.

At block 1114, the IsServerUp function then tries to connect to the connected data source server 801, e.g., using an “initialize” routine of the MA 418. The connection is attempted and at block 1116 the connected data source server 801 will respond if operational and communicating, i.e., up and running.

At block 1118, an exemplary PwdMgmtApp 426 consults configuration options, e.g., in an XML file, to determine whether or not attempts to set a password are to include those to be made over non-secure connections.

At block 1120, with respect to accounts for which an exemplary PwdMgmtApp 426 determines that a password set operation can be performed, the PwdMgmtApp 426 uses appropriate means to set the passwords, for example, in one MIIS implementation, a MIIS WMI API includes a SetPassword function.

At block 1122, in an MIIS implementation, the MIIS WMI API SetPassword function calls into the exemplary identity integration system 102 to an ExportPasswordSet function associated with the MA 418 that manages data flow between the connector object 412 and the corresponding connected data source (104) for which the SetPassword function was called. The ExportPasswordSet function pushes the new password out to the connected data source (104).

In one implementation, a rule extension, i.e., a call out for custom logic, is made for MAs that do not natively support password management (such as various MAs for files and databases). A user may use such a call out to extend the functionality of an exemplary web application and an interface 424, such as a WMI API, by providing logic to communicate with a system for which the exemplary identity integration system 102 cannot natively set passwords.

Back at block 1124, an exemplary identity integration system 102 communicates with the connected data source server 801 using credentials stored in the MA configuration and administratively sets the password for the account. In one implementation, if the credentials provided by the user are for a connected data source account 104 having the strongest password policy of all the accounts that appear in the account list on the webpage 428, then if the new password is accepted by that data source 104 the new password will not be rejected for reasons of policy violation by any of the other connected data sources (e.g., 106, 108) assuming their servers are available and all other configuration requirements have been met when the operation is attempted. In an alternative implementation, the new password is checked against a policy defined in an exemplary PwdMgmtApp 426 and stored with the exemplary identity integration system configuration so that passwords submitted via the interface(s) 424 have to satisfy the policy regardless of whether or not a connected data source (e.g., one of 104, 106, 108) implements such a policy.

At block 1126, a status (e.g., success or fail) of the password set and/or reset operation is logged with the connector object 412 for which the password set operation was attempted. In a WINDOWS® SERVER implementation, an entry may be generated (not shown) in a host operating system event log for each operation attempted. The entry can include the identity of the user who requested the password set operation (the help desk person, in this case), the date and time of the operation, the type of operation, and the outcome.

At block 1128, in one implementation a user-extensible callback module may be loaded by an exemplary PwdMgmtApp 426 in order to execute whatever code a user 120 wants to execute after each attempted operation. This custom code can perform diverse tasks ranging from performing additional logging to sending the user's manager an email. In addition, after the entire collection of connector objects has been processed, another function in the callback module can allow custom logic to perform an action based on the status of the entire collection of objects processed. For instance, a user 120 could use a callback to set passwords in other systems during the same session, using the same information that was just used. As mentioned, a user 120 can also employ custom logic to extend the method that exports a password set operation (at blocks 1120 and 1122).

At block 1130, the status of each password operation attempted and an overall status may be reported to the help desk support person.

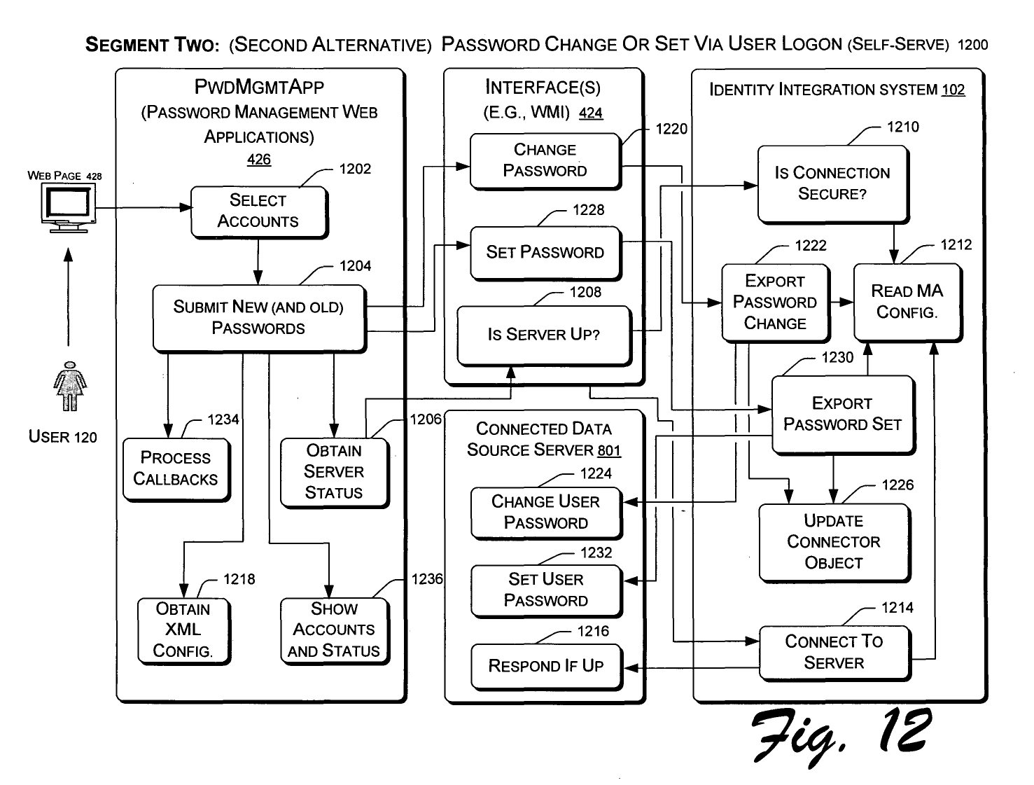

FIG. 12 shows an exemplary password change or set method 1200 via a user logon (self-service) that can be employed as a alternative second segment of a password management process that uses the exemplary first segment described above with respect to FIG. 8. In the following flow diagram, the operations are summarized in individual blocks. The processes in the flow diagram can be performed by example components in an exemplary password management system 400. Thus, the operations may be performed in hardware and/or as machine-readable instructions (software or firmware), e.g., that can be executed by a component of the exemplary password management system 400. The illustrated exemplary method 1200 describes at least in part interactions between a user 120, an exemplary PwdMgmtApp 426, an exemplary identity integration system 102, and exemplary interface(s) 424. In one implementation, the exemplary method 1200 is performed by components of an exemplary MIIS identity integration system.

At block 1202, a user 120 selects accounts for password management. The user 120 peruses the user's list of accounts that was generated (assuming configuration options allow) in a process such as exemplary method 1000. If configuration options allow, the user 120 may select and deselect accounts freely.

At block 1204, a user 120 may enter a new password 434 into an exemplary PwdMgmtApp 426. In order for the new password 434 to be changed where the change operation is supported, a user 120 must typically also enter their old password 432. The old password 432 verifies the user's identity and allows the user 120 to employ a password change application without being a member of any group.

At block 1206, the exemplary PwdMgmtApp 426 obtains a status of a connected data source server 801 at blocks 1208, 1210, 1212, 1214, and 1216, using a process described above with respect to FIG. 11.

At block 1218, the exemplary PwdMgmtApp 426 consults configuration options, e.g., in an XML file, to determine whether or not the attempt to change or set password(s) is to be made over non-secure connections as well.

Since the user 120 has provided their new password 434 and their old password 432, a first set of password management operations is performed on those connected data sources wherein a password can be changed as opposed to only set.

At block 1220, the exemplary PwdMgmtApp 426 calls a change password function, such as a WMI MIISCSObject.ChangePassword method, for those connected data sources having accounts where this function is valid. As mentioned, a change password function typically requires a user's old password 432 but does not require that the application pool identity perform any privileged operations by virtue of membership in any group.

At block 1222, a mechanism of the interface 424, e.g., a WMI provider, makes a call to an exemplary identity integration system's password change mechanism, such as an MIIS ExportPasswordChange method, for the identity of the MA 418 associated with the connector object 412 for which the change password function was called at block 1220.

At block 1224, the exemplary identity integration system 102 communicates with the connected data source server 801 using information from the MA configuration at block 1212, and passes the user's credentials and the user's old password 432 in order to change the formerly operative password to the new password 434. As with the set password method described above with respect to FIG. 11, it is assumed in one implementation that the strongest password policy is defined in that account wherein the user 120 logged in when they began using the exemplary PwdMgmtApp 426.

At block 1226, the status of the password change operation is logged with the connector object 412 for which the password change operation was attempted. As described above, the items logged may include the identity of the user who requested the password set operation (i.e., the help desk support person), the date and time of the operation, the type of operation, and the outcome.

At block 1228, regarding connected data sources (e.g., 106, 108) for which the exemplary PwdMgmtApp 426 determines that a set password operation must be performed because the data source does not provide a way to change the password with the existing MA (e.g., 420, 422), the exemplary PwdMgmtApp 426 uses a set password function, such as an MIIS MIISCSObject.SetPassword method. A set password operation is typically performed using the application pool identity. The application pool identity's membership in the appropriate group grants the account the right to perform this function.

At block 1230, in one implementation a mechanism of the interface 424, e.g., a WMI provider, makes a call to the exemplary identity integration system's ExportPasswordSet method or similar function for the identity of the MA (e.g., 420) associated with the connector object 414 for which the set password function at block 1228 was called.

At block 1232, the exemplary identity integration system 102 communicates with the connected data source server 801 using the credentials in the MA configuration at block 1212 and administratively sets the password for the connected data source 106.

Back at block 1226, the status of the set password operation is logged with the connector object 414 for which the password set operation was attempted. In a WINDOWS® SERVER implementation, an entry may be generated (not shown) in a host operating system event log for each operation attempted. The entry can include the identity of the user who requested the password set operation (the help desk technician, in this case), the date and time of the operation, the type of operation, and the outcome.

At block 1234, in one implementation a user-extensible callback module may be loaded by an exemplary PwdMgmtApp 426 in order to execute whatever code a user 120 wants to execute after each attempted operation. As above, this custom code can do diverse tasks from performing additional logging to sending the user's manager an email. After all connector objects have been processed, the exemplary PwdMgmtApp 426 may execute a callback to initiate additional functions based on the number of password operations that were successful, or perform other calculations or actions.

At block 1236, the status of each password operation attempted and an overall status may be reported to the user 120 and/or help desk support person.

It should be noted that since it is possible for some operations to fail unexpectedly, a retry timer (having a number of retry operations to attempt) can be employed so that an operation can be automatically performed again at a later time. Thus, a password management operation request can be stored and queried by help desk technicians trying to solve user password issues.

Security in Exemplary Password Management Operations

Typically an exemplary identity integration system 102 utilizes known security measures such as certifying authorities and secure socket layer (SSL) technology, so that a client using an exemplary PwdMgmtApp 426 trusts the certifying authority issuing certificates. A client and the server running an exemplary PwdMgmtApp 426 can thereby mutually authenticate each other and establish trust. Of course, if the server for an exemplary PwdMgmtApp 426 is the same server hosting the exemplary identity integration system 102, security between the two exists by virtue of no information having to be transmitted over an external wire. If the PwdMgmtApp 426 and the exemplary identity integration system 102 are on different servers, then other security measures such as IPsec for securing TCP/IP data may be used invisibly through a client application. A typical secure configuration, therefore, might include SSL from a user 120 to a web server, and IPsec from the web server to the exemplary identity integration system server and from the exemplary identity integration system server to the various connected data sources 104, 106, 108 that have the accounts that the user 120 wants to manage passwords on. In addition, MAs may have an option to configure secure communications for the connection they manage. In MIIS implementations, each type of system for a connected data source 104, 106, 108 that an MA can communicate with has a secure connection option having at least some kind of encryption wherein data is transferred over the wire in at least a garbled format.

Other security measures include a feature that user passwords are never stored in an exemplary metaverse 406. If an MA 418 is set up to communicate with an ACTIVE DIRECTORY® domain or forest, the MA configuration data may have a user ID and a password to be able to connect to its associated connected data source 104. But regarding user passwords for a user object 408 in the exemplary identity integration system 102, passwords are not saved and may be flushed from memory.

Some implementations of an exemplary identity integration system 102 may use encryption and decryption methods in the exemplary interface(s) 424 to encrypt, scramble, and/or garble data for transmission over non-secure channels, or to store password information in files, directories, and/or databases for later retrieval and propagation to other connected data sources. In some implementations, an exemplary identity integration system 102 may also use encryption of integrated identity information in the metaverse 406.

Exemplary Identity Integration System

As shown in FIG. 13, an exemplary identity integration system 102 according to the subject matter can be understood in terms of various layers. An exemplary rules layer 1302 provides rules (schemata, specifications, definitions, etc.) including exemplary flexible rules 1301—having call outs for custom logic—for implementing an exemplary identity integration system 102. These rules may drive, implement, or be actualized in various actions, agents, engines, and/or objects of other exemplary layers, such as an exemplary services layer 1304 for performing actions (e.g., management) and an exemplary storage layer 402 for holding information. In one implementation, the storage layer 402 has a connector space 410 (also called a “buffer”), which serves as an intermediate staging space for information 1310 going to or coming from a metaverse space 404 (also called a “core”). The connector space 410 may have its information 1310, 1332 imported in a process known as “staging” 1314 from connected data 1316 stored in one of multiple disparate connected data sources (e.g., one of 104, 105, 106, 107, 108), such as a directory, a MICROSOFT® ACTIVE DIRECTORY® type of directory, a SUN ONE server, a LOTUS NOTES server, an SQL type database, a lightweight directory access protocol (LDAP) directory, a file, a metadirectory system, and other proprietary database and email address repositories. The metaverse space 404 stores or persists information known as unified or “integrated identity information,” such as a user object 408, that is taken (i.e., preferred, selected, filtered, unified, integrated, etc.) from information 1310 in the connector space 410, such as a connector object (412), according to the rules in the rules layer 1302 in a process called “synchronizing” 1330(a), 1330(b). A piece or object of integrated identity information, such as the user object 408, provides a persistent view or representation of information that may be stored in many different forms and many different stages of completeness in the connected data sources (104, 105, 106, 107, 108).

Synchronizing 1330 between the metaverse space 404 and the connector space 410 can be “inbound” 1330(a) to the metaverse space 404 or “outbound” 1330(b) from the metaverse space 404. Thus, the integrated identity information in the metaverse space 404 is taken or derived only indirectly from the multiple disparate connected data sources since the connector space 410 intervenes. In synchronizing 1330, an exemplary flexible rule 1301 (e.g., embodied in an agent or service) performs (inbound) data aggregating by updating a piece of integrated identity information, such as the user object 408, in the metaverse space 404 based on information 1310 staged in the connector space 410 or, the same or another exemplary flexible rule performs (outbound) account managing by updating a piece of information 1332 in the connector space 410 based on a piece of integrated identity information, e.g., in the user object 408, in the metaverse space 404. Appropriate information from the updated information 1332 in the connector space 410 gets exported to an appropriate connected data source (e.g., one of 104, 105, 106, 107, 108).

For exporting 1334, the user may select an attribute or value viewed in a piece of integrated identity information, such as the user object 408, to be applied to all connected data sources. An exemplary flexible rule (i.e., a rule that includes a call out for custom logic) may create a staged object to reflect the attribute or value to be exported. The same or another exemplary flexible rule 1301 then exports the attribute change or value to each relevant connected data source 104, 105, 106, 107, 108.

Thus, once unified and/or integrated, the integrated identity information, such as a user object 408, in the metaverse space 404 may be used to administer the connected data sources. Through (outbound) synchronizing 1330(b), changes to a user object 408 can be represented in the connector space 410. Through “exporting” 1334, information 1332 in the connector space 410 can be distributed in order to change, augment, or replace information 1316′ in a connected data source 108.

Within this basic exemplary identity integration system 102 just described, the flexible rules 1301 provide opportunities for the user to customize the exemplary identity integration system 102 at many different points via flexible rule call outs 1303, without destroying the structure and function of the exemplary identity integration system 102. For example a flexible rule 1301 defining the process of staging 1314 may have a call out 1350 for custom logic that allows a user 120 to connect an unconventional data source, including password management, to the exemplary identity integration system 102 and perform custom filtering of attributes. A flexible rule 1301 defining an inbound synchronization process 1330(a) may have a call out 1352 for custom logic that allows a user 120 to create custom, even counterintuitive, integrated identity information objects consisting of rarely-used combinations of attributes. A flexible rule 1301 for outbound synchronizing 1330(b) may have a call out 1354 for custom logic that allows a user 120 to set up a unique system of automatically configuring accounts for new employees. Yet another flexible rule 1301 for exporting 1334 may have a call out 1356 for custom logic that allows a user 120 to perform custom password management on an unconventional connected data source or in an unconventional manner; or perform other custom actions such as outputting business updates to hundreds of heterogeneous accounts in various departments of a large multinational corporation.

In one implementation, an exemplary identity integration system 102 can be performed by a MICROSOFT® METADIRECTORY SERVICES metadirectory product or by a MICROSOFT® IDENTITY INTEGRATION SERVER (“MIIS”) products, e.g., “MIIS 2003” or just “MIIS,” providing an example environment for practicing the subject matter (Microsoft Corporation, Redmond, Wash.).

The services layer 1304 can use or embody exemplary flexible rules 1301 from the rules layer 1302 in MAs (e.g., 418. 420, 422) to cause information to flow and/or otherwise be manipulated. For example, in one implementation an MA embodying one or more of the exemplary flexible rules 1301 can discover the contents of a connected information source (e.g., one of 104, 105, 106, 107, 108), call out for custom logic, (for example, custom logic to perform a data transformation on some of the information) and then place object entries from the connected data source (e.g., 104) into the connector space 410 according the inherent logic of the flexible rule and/or the custom logic obtained from the call out 1303. The same or another exemplary flexible rule can then call out again for custom logic and place an appropriate object from the connector space 410 into the metaverse space 404 according to the inherent logic of the flexible rule and/or the custom logic. Further, another process using an exemplary flexible rule may call out for custom logic and cause mapping of at least some information (e.g., data, attributes, etc.) from an object in the metaverse space 404 to an object in the connector space 410 according to its inherent logic and/or the custom logic called out for. In the latter instance, yet another, or the original, process or agent using an exemplary flexible rule may yet again call out for custom logic and then cause mapping of at least some information from the object in the connector space 410 to a connected data source (e.g., 104) according to the inherent logic of the flexible rule and/or the custom logic obtained from the call out.

In general, the exemplary flexible rules used “alone” or as embodied in an agent, MA, process, schema, etc., may be configured to call out for custom logic and to act in any specific manner to define and/or control various processes according to the inherent logic in the exemplary flexible rule and/or the custom logic called out for. The custom logic, to reiterate, is information set up by a user or other entity outside an exemplary identity integration system 102. For example, each MA 418, 420, 422 that uses an exemplary flexible rule 1301 may be inherently configurable to deploy inclusion logic, exclusion logic, attribute flow rules, filters, join and projection rules, object deletion rules, provisioning and deprovisioning rules, etc. and also to call outside of the resources of the exemplary identity integration system 102, including the rules in the rule layers 1302 of the exemplary identity integration system 102, to obtain custom logic, e.g., from a user, not contemplated in stock customizations that might already be supplied with an exemplary identity integration system 102.

The exemplary flexible rules 1301 may allow a user 120 to perform actions, such as custom password management operations, beyond what may be performable in an MIIS IDENTITY MANAGER. For example implementing password changing, setting, and/or resetting on types of connected data that do not conventionally lend themselves to password management, creating new attribute values from a combination of existing attribute values, creating logic for sophisticated filters, resolving complex object conflicts, resolving unwanted “joins,” handling advanced object ownership and attribute precedence, transforming and converting data types between different systems, may be beyond stock customizations possible with a given exemplary identity integration system 102 or may be easier to implement with an exemplary flexible rule 1301. Sometimes there may be no obvious way to accomplish a task without an exemplary flexible rule call out 1303, for example, in some implementations wherein a new object needs to be provisioned into other systems. Upon detection or connection of a new information source to be connected by the exemplary identity integration system 102, an exemplary flexible rule may initiate a process that communicates information and generates an imported object into the connector space 410.

Some exemplary flexible rules 1301 can allow designers of identity integration systems much greater flexibility and power to implement business logic in identity integration services, such as password management. Some exemplary flexible rules 1301 may be usable with the MICROSOFT® .NET™ FRAMEWORK and can be created by a user or identity integration system administrator in a programming language that targets the MICROSOFT® COMMON LANGUAGE RUNTIME (CLR) (e.g., any programming language and compiler that creates a .NET™ FRAMEWORK class library, such as MICROSOFT® VISUAL BASIC .NET™, the C# programming language with the compiler shipped in MICROSOFT® VISUAL STUDIO®.NET™, MICROSOFT® PLATFORM SOFTWARE DEVELOPMENT KIT (SDK), etc.).

In an MIIS context, the call out 1303 aspect of some exemplary flexible rules 1301 can be embodied in a rules extension, for example, in a MICROSOFT® .NET™ Framework assembly. Such an example assembly can be a class library in the form of a dynamic link library (.dll) file that implements a customized set of instructions for managing information.

FIG. 14 shows an exemplary “identity information management process” (IIMP) 1400 that can be implemented using the exemplary flexible rules 1301 in the exemplary identity integration system 102. Exemplary flexible rules 1301 used in the exemplary IIMP 1400 can be customized using multiple simultaneous types of customization, such as the stock type of customization and the call out 1303 type of customization described above.

The exemplary IIMP 1400 includes the staging 1314, synchronizing 1330(a), 1330(b), and exporting 1334 described above, and when viewed with respect to integrated identity information, such as a user object 408, stored in a metaverse space 404, then added levels of processing may be introduced that aim to provide functionality and ensure data integrity across more than one connected information source (e.g., 1320, 1322, 1324, 1326, 1328). Such additional processes include, for example, data aggregating 1402, and account managing 1404. Further, such additional processes may have sub-processes. For example, data aggregating 1402 may include joining 1406, projecting 1408, importing attributes 1410, join resolving 1407, connector filtering 1415, and data transforming, auditing, and/or pre-processing 1411, including password management operations. Joining 1406, in one implementation, is the process of linking a buffer object to a core object. Exemplary flexible rules for importing attributes 1410 can define which attributes flow from the connector space 410 to the metaverse space 404. In one implementation, joining 1406 includes the process of relating parts of the integrated identity information 1311 to each other. Data transforming, auditing, and/or pre-processing during staging and/or import can include normalizing inbound data, changing data formats, performing password management operations, calling out to systems external to an exemplary identity integration system 102, such as workflow systems, to request or trigger further processing, etc . . . .

Account managing 1404 may include provisioning 1412, deprovisioning 1414, exporting attributes 1416, object deleting 1418, and data transforming, auditing, and/or post-processing 1420. Data transforming, auditing, and/or post-processing 1420 during export can include reformatting data for an external system, normalizing outbound data, performing password management operations, calling out to an external system, such as a workflow system, to request or trigger further processing, etc.

In general, such processes and/or sub-processes may be controlled by any of a variety of the exemplary flexible rules 1301 having call outs for custom logic that pertain to ensuring that the most valued, most correct, integrated identity information, such as a user object 408, resides in the metaverse space 404 and in one or more connected data sources (104, 105, 106, 107, 108), as appropriate.

Exemplary Computing Device

FIG. 15 shows an exemplary computer 1500 suitable as an environment for practicing aspects of the subject matter. The components of exemplary computer 1500 may include, but are not limited to, a processing unit 1520, a system memory 1530, and a system bus 1521 that couples various system components including the system memory 1530 to the processing unit 1520. The system bus 1521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Exemplary computer 1500 typically includes a variety of computer-readable media. Computer-readable media can be any available media that can be accessed by exemplary computer 1500 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by exemplary computer 1500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1530 includes computer storage media in the form of volatile and/or nonvolatile memory such as read only memory (ROM) 1531 and random access memory (RAM) 1532. A basic input/output system 1533 (BIOS), containing the basic routines that help to transfer information between elements within exemplary computer 1500, such as during start-up, is typically stored in ROM 1531. RAM 1532 typically contains data and/or program modules that are immediately accessible to and/or presently being operated on by processing unit 1520. By way of example, and not limitation, FIG. 15 illustrates operating system 1534, the exemplary identity integration system 102, application programs 1535, other program modules 1536, and program data 1537. Although the exemplary identity integration system 102 is depicted as software in random access memory 1532, other implementations of an exemplary identity integration system 102 can be hardware or combinations of software and hardware.

The exemplary computer 1500 may also include other removable/non-removable, volatile/nonvolatile computer storage media. By way of example only, FIG. 15 illustrates a hard disk drive 1541 that reads from or writes to non-removable, nonvolatile magnetic media, a magnetic disk drive 1551 that reads from or writes to a removable, nonvolatile magnetic disk 1552, and an optical disk drive 1555 that reads from or writes to a removable, nonvolatile optical disk 1556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1541 is typically connected to the system bus 1521 through a non-removable memory interface such as interface 1540, and magnetic disk drive 1551 and optical disk drive 1555 are typically connected to the system bus 1521 by a removable memory interface such as interface 1550.

The drives and their associated computer storage media discussed above and illustrated in FIG. 15 provide storage of computer-readable instructions, data structures, program modules, and other data for exemplary computer 1500. In FIG. 15, for example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537. Operating system 1544, application programs 1545, other program modules 1546, and program data 1547 are given different numbers here to illustrate that, at a minimum, they are different copies. A user may enter commands and information into the exemplary computer 1500 through input devices such as a keyboard 1562 and pointing device 1561, commonly referred to as a mouse, trackball, or touch pad. Other input devices (not shown) may include a microphone, joystick, game pad, satellite dish, scanner, or the like. These and other input devices are often connected to the processing unit 1520 through a user input interface 1560 that is coupled to the system bus, but may be connected by other interface and bus structures, such as a parallel port, game port, or a universal serial bus (USB). A monitor 1591 or other type of display device is also connected to the system bus 1521 via an interface, such as a video interface 1590. In addition to the monitor 1591, computers may also include other peripheral output devices such as speakers 1597 and printer 1596, which may be connected through an output peripheral interface 1595.

The exemplary computer 1500 may operate in a networked environment using logical connections to one or more remote computers, such as a remote computer 1580. The remote computer 1580 may be a personal computer, a server, a router, a network PC, a peer device or other common network node, and typically includes many or all of the elements described above relative to exemplary computer 1500, although only a memory storage device 1581 has been illustrated in FIG. 15. The logical connections depicted in FIG. 15 include a local area network (LAN) 1571 and a wide area network (WAN) 1573, but may also include other networks. Such networking environments are commonplace in offices, enterprise-wide computer networks, intranets, and the Internet.

When used in a LAN networking environment, the exemplary computer 1500 is connected to the LAN 1571 through a network interface or adapter 1570. When used in a WAN networking environment, the exemplary computer 1500 typically includes a modem 1572 or other means for establishing communications over the WAN 1573, such as the Internet. The modem 1572, which may be internal or external, may be connected to the system bus 1521 via the user input interface 1560, or other appropriate mechanism. In a networked environment, program modules depicted relative to the exemplary computer 1500, or portions thereof, may be stored in the remote memory storage device. By way of example, and not limitation, FIG. 15 illustrates remote application programs 1585 as residing on memory device 1581. It will be appreciated that the network connections shown are exemplary and other means of establishing a communications link between the computers may be used.

### CONCLUSION

The foregoing describes exemplary password management systems and related methods. The subject matter described above can be implemented in hardware, in software, or in both hardware and software. In certain implementations, the exemplary password management operations, exemplary password management web applications, exemplary interfaces, exemplary identity integration systems, exemplary flexible rules, identity information management processes, and other related methods may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

1. A method, comprising:
selecting multiple data sources connected to an identity integration system; and
performing a password operation on a password associated with at least one of the multiple data sources, wherein the password operation is performed using the identity integration system.

2. The method as recited in claim 1, further comprising:
determining an identity of a user, wherein the multiple data sources are associated with the identity; and
querying the identity integration system to find the multiple data sources associated with the identity.

3. The method as recited in claim 1, wherein the password operation comprises updating one or more passwords associated with the multiple data sources using joined objects across the multiple data sources, wherein the joined objects are stored in the identity integration system.

4. The method as recited in claim 3, wherein some of the multiple passwords are updated to new passwords that differ from each other.

5. The method as recited in claim 3, wherein each of the multiple passwords is updated to the same password.

6. The method as recited in claim 1, wherein the password operation comprises one of changing, setting and resetting the password.

7. The method as recited in claim 1, wherein each of the multiple data sources differ from others of the multiple data sources with respect to at least one of a protocol, a platform, a format, and a data transmission medium for data storage.

8. The method as recited in claim 1, wherein each of the multiple data sources differs in a connection to the identity integration system with respect to at least one of a protocol, a platform, a format, and a data transmission medium for data storage.

9. The method as recited in claim 1, wherein each of the multiple data sources uses a different password management function.

10. The method as recited in claim 9, wherein the identity integration system performs password management for each of the multiple data sources.

11. The method as recited in claim 1, wherein for at least some of the multiple data sources the identity integration system stores integrated identity information to perform password management.

12. The method as recited in claim 1, wherein the identity integration system includes a management agent for each of the multiple data sources to manage data communication between the identity integration system and each respective data source, and wherein for at least some of the multiple data sources a management agent for the data source is configured with credentials to perform password management.

13. The method as recited in claim 12, wherein the identity integration system includes a management agent for each of the multiple data sources to manage data communication between the identity integration system and each respective data source, and wherein for at least one of the multiple data sources a management agent for the data source calls for custom logic to perform password management for the data source.

14. The method as recited in claim 13, wherein the management agent calls for custom logic from a custom logic source outside the identity integration system.

15. The method as recited in claim 1, further comprising using the identity integration system to produce a list of user accounts associated with the multiple data sources, wherein the user accounts on the list are eligible for password management.

16. The method as recited in claim 1, further comprising allowing access to the identity integration system through a web application for password management.

17. The method as recited in claim 16, wherein the selecting multiple data sources and the performing a password operation are performed on a website generated by the web application.

18. The method as recited in claim 17, wherein the web application accepts a password credential from a user to perform the password operation.

19. The method as recited in claim 17, wherein the web application verifies an identity of a user by asking the user questions, wherein if answers provided by the user are correct then the web application performs the password operation using the identity of a privileged user account.

20. The method as recited in claim 17, further comprising using the identity integration system to produce a list of user accounts displayable on the website, wherein the user accounts are associated with the multiple data sources.

21. The method as recited in claim 17, further comprising a help desk to at least assist in the performing a password operation.

22. The method as recited in claim 17, further comprising communicatively coupling the identity integration system with the web application using an interface.

23. The method as recited in claim 22, wherein the interface is publicly available.

24. The method as recited in claim 22, wherein the interface allows a web application designer to customize the web application.

25. The method as recited in claim 22, wherein the interface includes password management functions.

26. The method as recited in claim 22, wherein the interface is capable of being changed for an improved version of the interface that adds more password management functions while using the same web application and the same identity integration system.

27. The method as recited in claim 22, wherein the interface is a WINDOWS MANAGEMENT INSTRUMENTATION interface.

28. The method as recited in claim 27, wherein the interface is secured using a security group.

29. The method as recited in claim 28, wherein the interface is secured using a security group that allows both searching for a connector object associated with a data source and setting a password for an object in the data source, wherein a connector object represents at least part of the data source in the identity integration system.

30. The method as recited in claim 1, wherein an identity of a user associated with the multiple data sources provides a security credential for performing a password operation.

31. The method as recited in claim 17, wherein the web application produces a list of accounts associated with a user.

32. The method as recited in claim 31, wherein the web application lists only accounts eligible for password management.

33. The method as recited in claim 17, wherein the web application adopts a web application behavior based on a configuration setting.

34. The method as recited in claim 33, wherein the configuration setting is stored in a configuration file.

35. The method as recited in claim 17, wherein the web application checks if one of the data sources is communicating before updating a password associated with the data source.

36. The method as recited in claim 35, wherein the updating comprises one of changing and setting the password.

37. The method as recited in claim 17, wherein the web application checks if a connection to one of the data sources is secure before updating a password associated with the data source.

38. The method as recited in claim 37, wherein the updating comprises one of changing and setting the password.

39. The method as recited in claim 1, further comprising displaying a status for the password operation.

40. The method as recited in claim 39, further comprising displaying the status on a webpage.

41. The method as recited in claim 1, further comprising auditing the password operation.

42. The method as recited in claim 41, further comprising maintaining a password management history for the password operation.

43. The method as recited in claim 42, further comprising keeping the password management history in a connector space object, wherein the connector space object is included in the identity integration system.

44. The method as recited in claim 42, wherein the password management history includes a tracking identifier to an audit record of the password operation.

45. The method as recited in claim 41, further comprising maintaining a repository of audit records for password operations performed using the identity integration system.

46. The method as recited in claim 45, wherein an audit record for a password operation includes at least one of an identifier of a user associated with the password operation, a tracking identifier to a web application initiating the password operation, a tracking identifier to a connector object associated with the password operation, a tracking identifier to a management agent associated with the password operation, a password operation identifier, a password operation status, a date, and a time.

47. The method as recited in claim 1, further comprising associating custom logic with a password operation, wherein the custom logic is executed after the password operation is performed.

48. The method as recited in claim 47, wherein the custom logic sends an email.

49. The method as recited in claim 47, wherein the custom logic logs password management activity.

50. The method as recited in claim 47, wherein the custom logic performs a password operation on a subsequent data source not connected to the identity integration system.

51. The method as recited in claim 1, wherein the password operation further comprises updating passwords in both secure and non-secure data sources within the multiple data sources.

52. The method as recited in claim 1, wherein the password operation further comprises updating passwords over both secure and non-secure connections to the multiple data sources.

53. A web application for password management, comprising:
a user identifier to find user identity information in an identity integration system;
identity information query logic to search information in the identity integration system for accounts associated with the user;
an account lister to display the accounts associated with the user;
an account selector to designate at least some of the displayed accounts for password management;
a password inputter to determine a new password; and
a password manager to request an update of a password associated with an account.

54. The web application as recited in claim 53, wherein the identity integration system connects with diverse data sources, each data source having a different function for using password security.

55. The web application as recited in claim 53, further comprising an account status display to show selected accounts and a connection status of each account.

56. The web application as recited in claim 53, further comprising a password management status display to display a password management operation status for each account.

57. The web application as recited in claim 53, further comprising a status checker to verify connectivity and security of a connection between an account and the identity integration system.

58. The web application as recited in claim 53, further comprising a configuration reader to obtain behavior settings for the web application.

59. The web application as recited in claim 53, further comprising a custom logic executor to perform custom logic associated with a password management operation.

60. The web application as recited in claim 53, wherein the account lister lists only accounts eligible for password management.

61. An interface for coupling an identity integration system with a password management web application, comprising:
logic for communicating with the identity integration system, wherein the identity integration system is capable of updating a password on data sources that use various functions of password updating;
logic for communicating with the password management web application;
logic for searching for objects in the identity integration system; and
logic for checking a connection status between the identity integration system and a data source.

62. The interface as recited in claim 61, further comprising logic for checking security of a connection between the identity integration system and a data source.

63. The interface as recited in claim 61, further comprising logic to change a password associated with the data source.

64. The interface as recited in claim 61, further comprising logic to set a password associated with the data source.

65. A password management system, comprising:
a identity integration system having a metaverse space for persisting integrated identity information regarding accounts associated with a user and a connector space for persisting information representing multiple data sources connectable to the identity integration system, wherein the accounts have associated manageable passwords;
a web application for producing a list of the accounts from the identity integration system, for allowing selection of at least some of the accounts, for inputting a password, and for requesting the identity integration system to update passwords on the accounts based on the input password; and
an interface to communicatively couple the identity integration system with the web application.

66. The password management system as recited in claim 65, wherein the password management web application verifies one of an identity and a credential of a user.

67. The password management system as recited in claim 65, wherein the web application generates a webpage that displays accounts and a status of a password management operation for each account displayed.

68. The password management system as recited in claim 65, wherein the web application operates in a security context.

69. The password management system as recited in claim 68, wherein the security context is an application pool identity.

70. The password management system as recited in claim 69, further comprising a help desk application, wherein the web application denies a user access to the help desk application if a security group of the user is not approved by the web application.

71. The password management system as recited in claim 65, wherein the identity integration system stores a password management operation history for each account.

72. The password management system as recited in claim 65, wherein the identity integration system communicates with diverse accounts, each account having a different mechanism for administering a password associated with the account.

73. The password management system as recited in claim 72, wherein the identity integration system does not natively communicate with at least some of the diverse accounts.

74. A management agent for an identity integration system, comprising:
logic for adapting a connection for data communication, wherein the connection couples an identity integration system using a first data communication format with a connected data source using a second data communication format; and
logic for requesting a connected data source to perform a password operation.

75. The management agent as recited in claim 74, wherein the management agent performs the password operation.

76. The management agent as recited in claim 74, wherein the management agent requests authorization for performing a password operation.

77. The management agent as recited in claim 74, wherein the management agent is configured with credentials to perform a password management operation.

78. The management agent as recited in claim 74, wherein the management agent is configured with credentials to request a password management operation.

79. The management agent as recited in claim 74, further comprising logic to perform a call out for custom logic for performing a custom password operation.

80. In a computer system having a graphical user interface including a display and a user interface selection device, a method of providing and selecting from a menu on the display comprising the steps of:
retrieving a list of user accounts from an identity integration system having persisted identity information regarding the user accounts;
showing the list of user accounts on the display;
allowing each account in the list to be selected using the user interface selection device;
allowing input of a new password via the user interface selection device; and
allowing input of a request to update old passwords associated with the selected accounts to the new password.

81. The method in the computer system having the graphical user interface as recited in claim 80, further comprising allowing input of user credentials to verify an identity of the user.

82. One or more computer readable media containing instructions that are executable by a computer to perform actions, comprising:
selecting multiple data sources connected to an identity integration system; and
for at least one of the multiple data sources, using the identity integration system to perform a password operation.

83. The one or more computer readable media as recited in claim 82, wherein at least some of the multiple data sources connected to the identity integration system communicate in a manner different than a native communication of the identity integration system.

84. The one or more computer readable media as recited in claim 82, wherein the identity integration system accomplishes a password update on each of the data sources regardless of whether the data sources connected to the identity integration system communicate in a manner different than a native communication of the identity integration system.

85. The one or more computer readable media as recited in claim 84, wherein the identity integration system accomplishes a password update on at least one of an ACTIVE DIRECTORY® data source, a SUN ONE server data source, a LOTUS NOTES server data source, a WINDOWS® NT™ server data source, a NOVELL® EDIRECTORY™ server data source, and a flat file data source.
